(19) United States
(12) Patent Application Publication
(10) Pub. No.: US 2017/0087436 A1
(43) Pub. Date: Mar. 30, 2017

(54) SYSTEM FOR GENERATING A DYNAMIC AND INTERACTIVE USER-INTERFACE UTILIZED TO IMPROVE STRIKING AND PUTTING GOLF BALLS

(71) Applicant: Jack W. Peterson, Elk Ridge, UT (US)

(72) Inventor: Jack W. Peterson, Elk Ridge, UT (US)

(21) Appl. No.: 15/256,452

(22) Filed: Sep. 2, 2016

Related U.S. Application Data
(63) Continuation-in-part of application No. 14/949,545, filed on Nov. 23, 2015.
Application No. 14/949,545 is a continuation-in-part of application No. 14/538,129, filed on Nov. 11, 2014, now Pat. No. 9,526,958.
Application No. 14/538,129 is a continuation-in-part of application No. 13/737,837, filed on Jan. 9, 2013, now Pat. No. 8,992,345.
Application No. 13/737,837 is a continuation-in-part of application No. 12/240,086, filed on Sep. 29, 2008.
(60) Provisional application No. 62/213,976, filed on Sep. 3, 2015.
(60) Provisional application No. 62/083,013, filed on Nov. 21, 2014.
(60) Provisional application No. 61/585,122, filed on Jan. 10, 2012.

(51) Int. Cl. A63B 71/06; A63B 57/00

(52) U.S. Cl. CPC A63B 71/0619; A63B 57/00; H04W 88/08

(57) ABSTRACT

Methods and system generating data utilized to create, populate, and format a dynamic and interactive user interface for improving a golfer's driving and putting are disclosed. The system that may be utilized by golfers to improve ball striking and putting, comprising a base station, a server system, and a digital ball marker. Wherein the system may comprise a digital ball marker that is placed proximate to the golf ball, which may be utilized to determine the ball position signals generated by a satellite-based navigation system and signals generated, received, and processed by a base station. A provider's server system may then be utilized to generate calculated recommended golf shot parameters using the position of the ball, the known position of the hole, a topographical data set, previously populated data related to a particular user, and real-time environmental conditions. A ball marker or mobile computing device may then be utilized to display a dynamic, customized, and interactive user interface comprising recommended golf shot parameters to the golfer along with statistics associated with the recommended parameters and information associating the recommended parameters and golfer's statistics with a designated group. The system is structured to interact with a social networking platform allowing comparison, comment, and discussion with the user's selected online social network.

### CROSS-REFERENCE TO RELATED APPLICATIONS

This application claims the benefit of U.S. Provisional Patent Application No. 62/213,976 (Attorney Docket No. 16649.16), filed on Sep. 3, 2015, and entitled “METHODS AND SYSTEMS FOR IMPROVING GOLF SHOT MAKING.” This application is a continuation-in-part of U.S. patent application Ser. No. 14/949,545 (Attorney Docket No. 16649.11), filed Nov. 23, 2015, and entitled “SYSTEMS AND METHODS FOR DETERMINING OPTIMUM PUTTING SPEED AND ANGLE,” which claims the benefit of U.S. Provisional Patent Application No. 62/083,013 (Attorney Docket No. 16649.8), filed Nov. 21, 2014, and entitled “SYSTEMS AND METHODS FOR DETERMINING OPTIMUM PUTTING SPEED AND ANGLE,” and is also a continuation-in-part of U.S. patent application Ser. No. 14/538,129 (Attorney Docket No. 16649.9), filed Nov. 11, 2014, and entitled “DIGITAL BALL COMPASS MARKER”, which is a continuation-in-part application of U.S. patent application Ser. No. 13/737,837 (Attorney Docket No. 16649.6), filed Jan. 9, 2013, and entitled “DIGITAL BALL COMPASS MARKER” (now U.S. Pat. No. 8,992,345), which claims the benefit of U.S. Provisional Application No. 61/585,122 (Attorney Docket No. 16649.5), filed Jan. 10, 2012, and is entitled “DIGITAL BALL COMPASS MARKER”, and is a continuation-in-part application of U.S. application Ser. No. 12/240,086 (Attorney Docket No. 16649.2), filed Sep. 29, 2008, and entitled “METHOD AND DEVICE FOR IMPROVING PUTTING”, all of which applications are incorporated by reference for all they disclose.

### BACKGROUND

Various tools, equipment, and software applications to improve golfers' ability to play and enjoy the game have been developed over time. Golf is played on golf courses that include various terrain features, including tees, fairways, roughs, woods, water hazards, sand traps (or bunkers), and golf greens (commonly referred to as “the green”). The terrain of the golf course is generally varied so as to enhance the difficulty and play experience of the golf course. The greens further include a hole into which the golfer attempts to place the golf ball.

A great deal of skill, practice, dedication, and precision is required to develop reliable golfing prowess including a variety of skills, including ball striking, pitching, chipping, and putting. In addition to mastering the mechanics of a golf swing, various physical contours, properties and obstacles on the course must be analyzed by the player to aid the player in accurately striking the ball onto the green and putting the ball into the hole. Distance to the hole, lines, slopes, grades, wind speed, wind direction, wetness or dryness of the grass, the length of the grass, the grain of the grass and other variables must be taken into account when determining the direction and swing speed of the golf club.

Some of the most important considerations when putting are the position of the ball on the green and the distance between the ball and the hole. A player's likelihood of success largely depends upon the player determining these pieces of information. Once the position and distance has been determined, the player may adjust his or her swing accordingly. The position of the ball and the distance between the ball and the hole is typically gauged by pacing or is otherwise estimated by the player. Accordingly, it is difficult to obtain an accurate measurement.

In some cases, a golfer can employ a person (or a caddy) that is familiar with a course. The caddy can offer the golfer advice on where to aim, how hard to hit a shot, what type of shot to hit, what type of club to select, etc. However, caddies are generally not available for the average golfer. To address this, technology has been used to provide digital caddies in the form of electronics that provide much of the information generally provided by a caddy. For example, some electronic devices are available that provide a distance to the front, middle or back of the green or an obstacle to assist the golfer in selecting the appropriate club, type of shot, and swing force. Such devices are useful when hitting a drive, approach shot, or other relatively longer distance shot where precision is less important. However, when putting or chipping on the green, where both the direction and force of the shot must be precisely determined, the usefulness of such electronic devices are limited. Another limitation of these electronic devices is that their use may unacceptably slow play of the game.

Therefore, there is a need in the industry for new methods and systems that improve both driving and putting. Such methods and systems are disclosed herein.

### BRIEF SUMMARY

Methods and systems of generating and formatting a dynamic and interactive user interface utilizing a digital ball marker which accesses topographical data from a server system, position data utilizing triangulation methods and/or GPS data provided by satellite communications, variable course conditions from a server system, and/or using previous data for improving driving and putting are disclosed. In some embodiments, the present application discloses methods and systems for improving driving and putting that can comprise a base station, a server system, and a digital ball marker. The base station can be configured to receive carrier wave signals from a satellite-based navigation system and to transmit phase measurements of the carrier wave signals. The server system can comprise a topographical data set and can be configured to calculate recommended golf shot parameters using a position of a ball, a known position of a hole, and the topographical data set. The digital ball marker can be placed proximate to the position of the ball lying on a tee box (teeing ground), fairway, rough area, bunker area, and the green and can be activated. The ball marker can also comprise a receiver configured to receive signals from the satellite-based navigation system and configured to receive phase measurements of the carrier wave signals from the base station with the ball marker calculating the position of the ball by using the received signals and the received phase measurements. The ball marker can comprise a communication module configured to transmit the position of the ball to the server system and to receive the recommended golf shot parameters for each shot the golfer faces and eventually stroking the ball into the hole. The ball marker can comprise a display for displaying the recommended golf shot parameters, and may also comprise a communications module for allowing an application, resident on the user's smartphone and/or other handheld device, to display an interactive display providing the user with shot making information and/or access to the user's historical shot making data, and/or data from other games.

In some embodiments the software resident on the provider's screen allows information germane to the users, by comparison to other users with demographic information similar to the user (e.g., golfers with similar handicap, age, etc.), to be displayed to the user.

In other embodiments, the present application discloses methods and systems for improving putting that can comprise a digital ball marker for determining the location of a ball on a golf green. The ball marker can comprise a receiver, a communication module, and a display. The receiver can be configured to receive signals from a satellite-based navigation system and a base station with the receiver calculating a position of the ball by using the received signals. The communication module can be configured to transmit the position of the ball to a server system and can be configured to receive recommended golf shot parameters for stroking the ball into the hole from the server system. The recommended golf shot parameters can be calculated using the position of the ball, a known position of the hole, and a topographical data set of the golf course. The recommended shot parameters may also be displayed by way of comparison to other golfers that have faced similar shots historically (e.g., that day, month, year, etc.). The display can be configured to display the recommended putt parameters.

In yet other embodiments, the present application discloses methods and systems for improving driving and putting that can comprise utilizing a digital ball marker comprising a receiver, wherein the receiver is configured to receive signals from a satellite-based navigation system and a base station as well as the user's historic shot making dating, and/or historic shot making data from other users, including but not limited to peers with similar demographic information, golf performances, and historic records for other users that face a similar shot and/or with the results of historic shot making data (e.g., how close to the pin others facing a similar shot have gotten the ball, what percentage of golfers with a similar handicap have holed-out the particular shot, average distance from the pin for other users from a similar position, etc.). The method can also comprise placing the ball marker on the putting surface proximate to a position of a ball lying on a surface. The method can also comprise receiving signals with the ball marker from the satellite-based navigation system and the base station. The method can also comprise calculating a position of the ball from the received signals. The method can also comprise determining an aim point toward which the ball should be struck to arrive on the green or in the cup. The method can also comprise determining an optimal speed and/or force with which the ball should be struck toward the aim point such that the ball arrives on the green or in the cup. The method can also comprise utilizing the ball marker to provide the aim point indicating the position toward which the ball should be struck. The method can also comprise utilizing the ball marker to provide the optimal speed with which the ball should be struck.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates an exemplary computer environment in which the present invention can be implemented;

FIG. 2 illustrates an exemplary configuration of a ball marker;

FIG. 3A illustrates a top view of a golf course hole on which a ball marker is used in accordance with one or more embodiments of the present invention;

FIG. 3B illustrates a side cross-sectional view of a green on which a ball marker is used in accordance with one or more embodiments of the present invention;

FIG. 4A illustrates a satellite-based navigation system;

FIG. 4B illustrates a Real Time Kinematic satellite-based navigation system;

FIG. 5A illustrates a top view of a golf course hole on which a ball marker is used to determine and display recommended golf shot parameters;

FIG. 5B illustrates a perspective view of a green on which a ball marker is used to determine and display recommended golf shot parameters;

FIGS. 6A-6C illustrate exemplary views of a display on a ball marker that is used to display recommended golf shot parameters to a golfer;

FIG. 7 illustrates a flowchart of an exemplary method for generating recommended putt parameters for putting a golf ball on a green;

FIG. 8 illustrates a flowchart of an exemplary method for generating golf shot parameters for driving a golf ball on a golf course hole;

FIGS. 9A-9D illustrate some embodiments of screen shots that can be displayed during startup of a software application for improving golf stroking;

FIGS. 10A-10E illustrate some embodiments of screen shots that can be displayed as a player begins game play or practice play;

FIGS. 11A-11D illustrate some embodiments of screen shots that can be displayed as a player drives from a tee box to a green; and

FIGS. 12A-12G illustrate embodiments of screen shots that can be displayed as a player putts a ball on a green.

### DETAILED DESCRIPTION OF THE INVENTION

In some embodiments, the present application discloses methods and systems for improving driving and putting that can comprise a base station, a server system, and a digital ball marker. In other embodiments, the base station can be configured to receive signals from a satellite-based navigation system and to transmit calculated phase measurements. In yet other embodiments, the server system can comprise a topographical data set and can be configured to calculate recommended golf shot parameters using a position of a ball, a known position of a hole, and the topographical data set. The digital ball marker can comprise a receiver, a communication module, and a display. First, the ball marker can be placed proximate to the position of the ball on the surface of the golf course. Next, the ball marker can be activated and the receiver can receive signals from the global navigation satellite system and can receive phase measurements from the base station. The ball marker can then calculate the position of the ball by using the received signals and the received phase measurements. Then, the communication module can transmit the position of the ball to the server system and can receive the recommended golf shot parameters for each golf shot the golfer faces. The display can display the recommended golf shot parameters to the golfer. Additionally, recommended shot parameters and historical data from other users facing a similar shot may be transmitted to a handheld device or smartphone, allowing the user to compare his current shot to his/her previous efforts and/or the efforts of others similarly situated in the past.

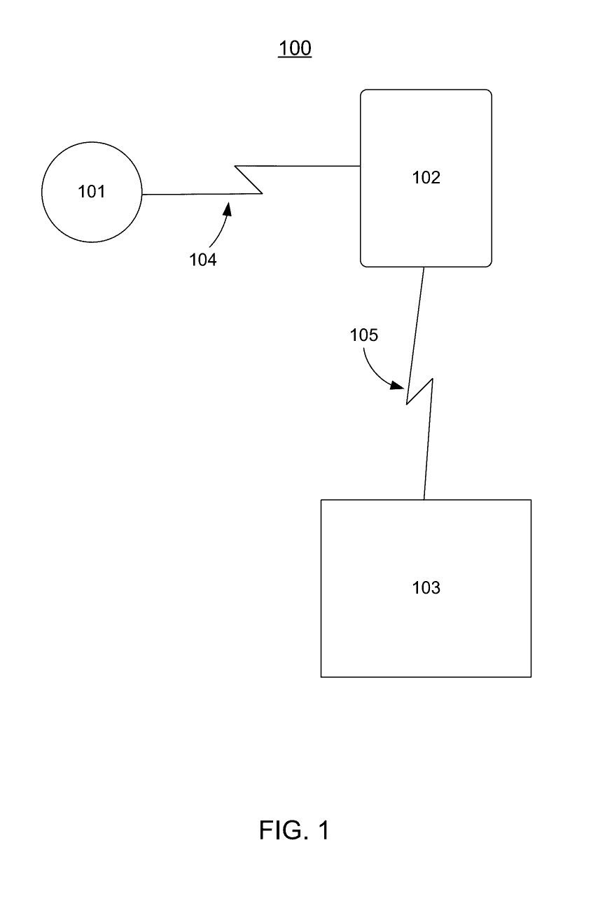

FIG. 1 illustrates an exemplary computing environment 100 in which the present disclosure can be implemented. Computing environment 100 represents a typical implementation of the present disclosure; however, as clarified below, other implementations are also possible.

Computing environment 100 includes a digital ball marker 101 that is connected to a mobile computing device 102 (e.g. a smart phone) via connection 104. Connection 104 can typically be a Bluetooth connection; however, any other type of connection over which two computing devices can communicate could be used. Mobile computing device 102 is connected to server system 103 via connection 105. Connection 105 can typically be a mobile network data connection; however, any other type of connection can also be used.

Mobile computing device 102 can be any type of computing device that can be carried by the golfer. In a typical example, mobile computing device 102 can be the golfer's smart phone having an app for communicating with ball marker 101 and server system 103. Server system 103 represents any number and type of interconnected server computing resources. For example, server system 103 can represent a cloud of computing resources or a single server. Accordingly, the particular architecture of mobile computing device 102 and server system 103 is not essential to the disclosed methods and systems.

In some embodiments, a golfer will carry ball marker 101 and mobile computing device 102 onto the golf course, and use ball marker 101 to mark his or her ball. Ball marker 101 communicates information to mobile computing device 102 which is routed to server system 103. Server system 103 uses the information to calculate the force and direction information for the shot and routes this information back to ball marker 101 via mobile computing device 102. Ball marker 101 and/or mobile computing system 102 can then display the force and direction information to the golfer to assist the golfer in playing the shot, as well as provides the user with his/her historic shot making data and the data of other users, allowing the user to interact with the recommendation and historic shot making data. In some embodiments, the function of the ball marker 101 and the mobile computing device 102 can be integrated into one device. In other embodiments, the ball marker 101 can be configured to be attached to the mobile computing device 102 (e.g. with a docking station). In yet other embodiments, the ball marker 101 can be configured as an accessory that can be detachably coupled to the mobile computing device 102 (e.g. via a docking assembly).

In typical usage, a golfer will carry ball marker 101 and mobile computing device 102 onto the golf course, and use ball marker 101 to mark his or her ball. The golfer uses ball marker 101 to mark his or her ball by placing or holding the ball marker 101 proximate to the ball and activating ball marker 101. The ball marker 101 can be activated by pressing a button on the ball marker 101 or by activation via the mobile computing device 102. Ball marker 101 communicates information to mobile computing device 102 which is routed to server system 103. Server system 103 uses the information to calculate the force and direction information for the shot, which may include the user's historic information and/or historic information generated by others users, and routes this information back to mobile computing device 102. Mobile computing device 102 can then display the force and direction information to the golfer to assist the golfer in playing the shot, the user's historic information, and/or data from other users who have faced a similar shot. In some embodiments, the function of the mobile computing device 102 and the server system 103 can be integrated into one device such that the computer processor of the mobile computing device 102 is configured to function as the server system 103. In other embodiments, the server system 103 can comprise the processor of the mobile computing device 102 and/or the operating system of the mobile computing device 102. In yet other embodiments, the function of the mobile computing device 102 and the server system 103 can be integrated into one device such that the computer processor of the mobile computing device 102 is configured to function as the server system 103 and the connection 105 can be a direct wired connection.

Exemplary Ball Marker

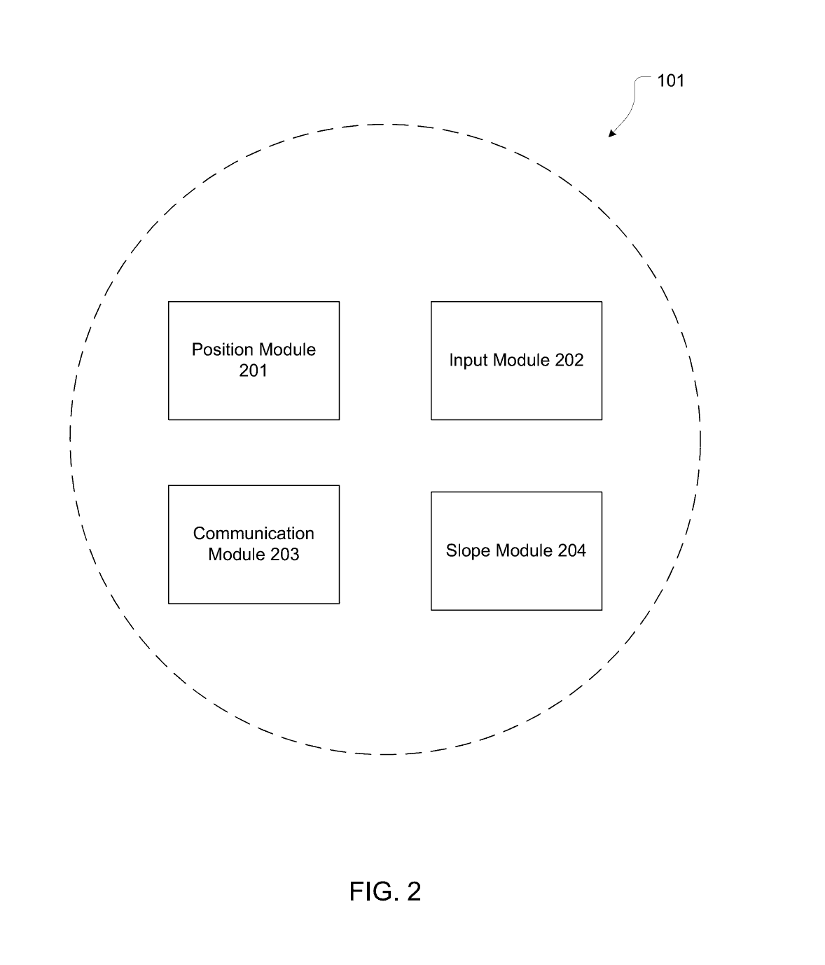

FIG. 2 illustrates ball marker 101 in further detail. As shown, ball marker 101 can include a position module 201, an input module 202, a communication module 203, and/or a slope module 204. Position module 201 can be used to determine a position of a ball proximate to where the ball marker is placed. The role of position module 201 will be further described below. Input module 202 comprises any type of logic or circuitry for receiving user input. For example, input module 202 can comprise components for receiving user input via a touch screen, buttons, wheels, speech, etc. In some embodiments, the input module 202 can comprise a mechanical push-button, a virtual button displayed on a computer screen, or a web-based button graphic. In other embodiments, the input module 202 can comprise a mechanical push-button configured to be pressed by a golfer to activate the ball marker 101. Similarly, communication module 203 can comprise any type of logic or circuitry for communicating with another computing device such as mobile computing device 102. For example, communication module 203 can include components for communicating using Bluetooth, Wi-Fi, Infrared, NFC, or any other suitable type of communication protocol.

Slope module 204 can comprise any type of circuitry or device for determining the slope of the ball marker relative to the horizon. For example, slope module 204 can comprise any type of accelerometer or gyroscope to determine the slope of the terrain where the ball marker is placed. In some embodiments, the slope module 204 can determine a slope at a position of a ball proximate to where the ball marker is placed. In other embodiments, the slope module 204 can determine a slope of a position of a ball proximate to where the ball marker is placed and the orientation of the slope in relation to the position of the ball and a position of a hole. In yet other embodiments, slope module 204 can receive data from position module 201 to determine the slope. In some embodiments, slope module 204 can receive data from position module 201 to determine the slope of the ball marker based on the determined horizontal and vertical position. In other embodiments, slope module 204 can receive data from position module 201 to determine the slope of the ball marker based on comparing the determined horizontal and vertical position with known topography data.

In yet other embodiments, the ball marker 101 can further comprise a digital compass module configured to determine true north and/or magnetic north and the orientation of a ball and hole (or cup) with respect to true north and/or magnetic north. In some embodiments, the determined true north and/or magnetic north and the orientation of a ball and hole (or cup) with respect to true north and/or magnetic north can be used as additional data to determine the location of the ball, the location of the hole, and/or to determine recommended golf shot parameters. In other embodiments, the determined true north and/or magnetic north and the orientation of a ball and hole (or cup) with respect to true north and/or magnetic north can be used to enhance determination of the ball position by the satellite-based navigation system. In yet other embodiments, the determined true north and/or magnetic north and the orientation of a ball and hole (or cup) with respect to true north and/or magnetic north can be used to enhance determination of the ball position by the satellite-based navigation system by providing an approximate initial position.

In some embodiments, position module 201 can comprise a satellite-based positioning system to determine a position of a ball proximate to where the ball marker is placed. In other embodiments, position module 201 comprises a global or regional satellite-based positioning system usable in conjunction with Global Positioning System, GLONASS, Galileo, COMPASS/Beidou2, IRNSS, and/or Quasi-Zenith Satellite System (QZSS). In yet other embodiments, position module 201 comprises a Real Time Kinematic global satellite navigation system. In some embodiments, position module 201 comprises a Real Time Kinematic global satellite navigation system such as a Piksi RTK module available from Swift Navigation, Inc. In other embodiments, the Piksi RTK module can be configured for centimeter accurate relative positioning with carrier phase RTK, 50 Hz position/velocity/time solutions, and/or 3-bit, 16.368 MS/s L1 front end. In yet other embodiments, the Piksi RTK module can be configured to cover L1 GPS, GLONASS, Galileo, and/or SBAS signal bands. In other embodiments, the Piksi RTK module can be configured to cover L2 signal bands. In some embodiments, the Piksi RTK module can comprise an external antenna. In other embodiments, the Piksi RTK module can comprise a USB socket to provide connectivity to a host.

In some embodiments, position module 201 is configured as a separate module. In other embodiments, position module 201 is configured as a separate module configured to detachably couple to ball marker 101 and/or computing device 102. The position module 201 can be configured to communicate with ball marker 102 and/or computing device 102 (e.g. via a wired connection or a wireless connection such as WiFi, Bluetooth, and/or any other suitable wireless connection). In some aspects, the mobile computing device 102 can be configured as the ball marker 101. For example, the mobile computing device 102 can comprise a smartphone configured to function as a ball marker 101. In this example, the position module 201 can be configured as a separate module configured to communicate with the smartphone configured as the mobile computing device 102 configured as the ball marker 101. In some aspects the position module 201 can be detachably coupled to the smartphone configured as the mobile computing device 102 configured as the ball marker 101.

Determining Recommended Golf Shot Parameters Using a Ball Marker

In general, golf play can be divided into two parts, striking the ball from the tee and/or fairway/first cut/rough to the green, and putting the ball on the green into the hole or cup. Striking the ball from the tee to the green can involve driving the ball with more force and/or over longer distances. Striking the ball from the tee to the green can also include avoiding obstacles and hazards, taking into account environmental conditions, and/or selecting the appropriate club(s). Putting the ball on the green into the hole or cup often involves more precise play with factors such as the force of the putting swing, direction of aim, slope of the green, speed of the green, type of grass on the green, direction of the green, etc. factoring into successfully sinking the putt. The present disclosure enables the quick determination of recommended golf shot parameters for both striking the ball from the tee, fairway, first cut, rough, etc., to the green and putting the ball on the green into the hole or cup.

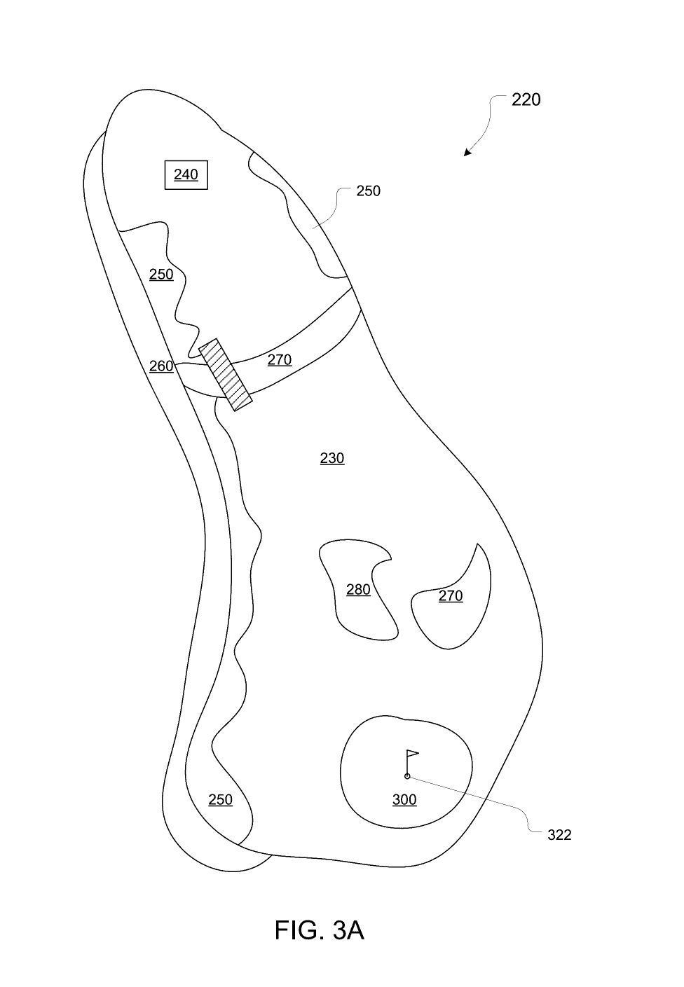

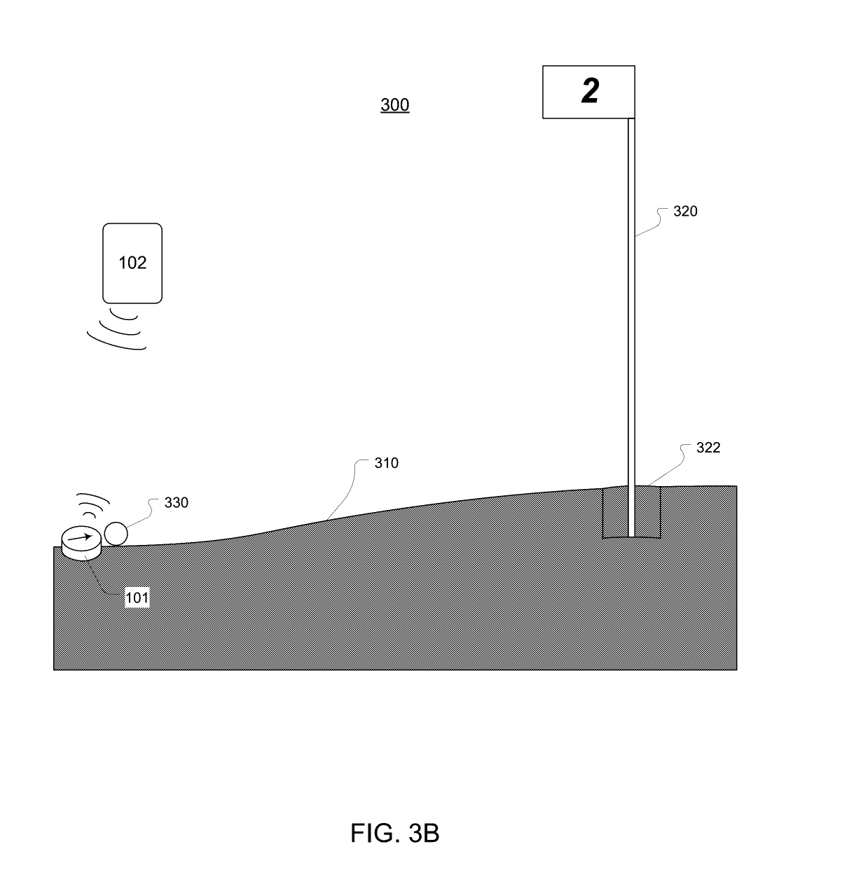

Referring now to FIG. 3A, a top view of a golf course hole 220 is shown to depict striking a ball from the tee to the green. Golf course hole 220 generally comprises a fairway 230 having a teeing ground (tee box) 240 at one end, and a green 300 on an opposite end. The fairway 230 can comprise grass that is cut short and even. The fairway 230 can be bounded by areas where the grass is cut higher than that of the fairway 230, referred to the first-cut, and even taller grass known as the rough 250. The area beyond the rough 250 that is outside the area of play is known as out of bounds 260. The fairway 230 can also comprise other physical features or obstacles known as hazards. Such hazards can include water obstacles 270, sand traps (or bunkers) 280, and/or rough vegetation and other natural features. During play, a golf player attempts to stroke his or her ball 330 from teeing ground 240 to the green 300, and into a hole or cup 322 in as few strokes as possible. Preferably, a player desires to stroke the ball 330 from the teeing ground 240 to the green 300 in one, two or three strokes, depending on the length of the hole, par for the hole, course conditions, and/or the golfer's ability to strike certain clubs a particular distance. Accordingly, a player must account for the fairway 230, location of the teeing ground 240, rough 250, out of bounds 260, water obstacles 270, sand traps 280, and/or location of the green 300 when striking the ball 330 from the teeing ground 240 to the green 300. Preferably, a player desires for the ball 330 to remain on the fairway 230 when struck from the tee box because it is easier to stroke the ball 330 on the short and even grass, and the ball flight including the distance the ball files in the air and/or rolls on the ground after flight is more consistent and predictable. A player also preferably avoids hazards because once a ball 330 lands in a hazard, subsequent hitting of the ball 330 can be difficult or impossible and can “cost” the player additional strokes.

To accurately provide golf shot parameters for striking a ball 330 from the teeing ground 240 to the green 300, several pieces of information must be known, including the position of ball 330 on the golf course hole 220, the position of the green 300 on the golf course hole 220, and the topography of the golf course hole 220. The topography of the golf course hole 220 can include the location of the fairway 230, the teeing ground 240, the rough 250, water obstacles 270, sand traps 280, and/or any other natural features that may affect the driving of the ball 330 to the green 300. Also, in some embodiments, information related to environmental conditions such as wind, wind gusts, precipitation, humidity, altitude, user's historical data, and/or barometric pressure can be included to provide golf shot parameters for striking the ball 330. In other embodiments, other information such as relative moisture of the fairway, length of grass, type of grass, grain of grass, time of day, season of the year, can be included to provide golf shot parameters for striking the ball 330 and provide a basis for the golfer to compare his shot making with other players with similar demographic information (e.g., age, handicap, sex, etc.), and/or with professional players of interest to the golfer. Furthermore, in yet other embodiments, other information such as a player's past performance on a particular golf course hole 220, a player's past performance with a specific club, other players' past performance on a particular golf course hole 220, and/or other players' past performance with a specific club can be included to provide golf shot parameters for striking the ball 330. The present disclosure enables the quick determination of the required information and the calculation of recommended golf shot parameters for driving the ball 330 in an accurate manner without slowing play.

First, the topography of the golf course hole 220 and the position of the green 300 can be preprogrammed into server system 103. Any changes to the topography of the golf course hole 220 or the green 300 can be updated in the server system 103. Likewise, any changes in the environmental conditions (e.g., weather, temperature, etc.) or other information can be updated in the server system 103. In some embodiments, any changes in the environmental conditions or other information can be updated in the server system 103 in real time. Similarly, the other information such as a player's past performance on a particular golf course hole 220, a player's past performance with a specific club, other players' past performance on a particular golf course hole 220, and/or other players' past performance with a specific club can also be updated on the server system 103. Next, the position of the ball 330 on the golf course hole 220 can be determined by ball marker 101. The position of the ball 330 can then be sent to server system 103 and recommended golf shot parameters for striking the ball 330 to the green 300 and/or a desired position in the fairway 230 can be determined and transmitted to the player. These recommended golf shot parameters can include selection of club, direction of aim, amount of force of swing and other parameters. Lastly, if ball 330 fails to reach green 300 on the first stroke, the position of the ball 330 on the golf course hole 220 can again be determined by ball marker 101, and new recommended golf shot parameters for striking the ball 330 to the green 300 or to a preferred position in the fairway 230 can be determined and communicated to the player. The process can be repeated until the ball 330 reaches the green. In some embodiments the golfer may be presented with risky options (e.g., striking the ball 330 with a driver a long distance over an obstacle landing closer to the green or on it), and/or more conservative play options (e.g., using an iron to “lay-up” in an area of the fairway 230, which decreases the probability of hitting the ball into an obstacle, and/or out-of-bounds, but decreased the probability that the golfer will get a “birdie” or “eagle” on the hole), effectively allowing the golfer to manage the risk/reward element of golf selection.

In some embodiments, the recommended golf shot parameters for striking the ball 330 to the green 300 and/or preferred position in the fairway 230 can include a recommendation that a player strike the ball 330 as a “drive” with a “full swing.” The recommendation can also include a recommended club that is compatible with a full swing. In other embodiments, the recommended golf shot parameters for driving the ball 330 to the green 300 or preferred position in the fairway 230 can include a recommendation that a player strike the ball 330 as an “approach” with a “three-quarters swing,” and/or recommended swing force. The recommendation can also include a recommended club that is compatible with a “three-quarters swing,” and/or recommended swing force. In yet other embodiments, the recommended golf shot parameters for striking the ball 330 to the green 300 or preferred position in the fairway 230 can include a recommendation that a player strike the ball 330 as a “chip,” with a “half swing,” and/or any ideal proportion of a full swing providing the appropriate amount of force given the club selection, the player's historic data, and/or other factors including but not limited to wind direction and wind velocity. The recommendation can also include a recommended club that is compatible with a “half swing,” a “knock-down” shot, a “fade,” a “draw,” and/or any shot type that may be used to increase the golfer's probability of hitting the ball 300 to a desired position given the topography, weather conditions, and golfers relative ability to hit particular shots with relative dependability and consistency.

Referring now to FIG. 3B, a cross-sectional side view of a green 300 is shown to depict putting a ball 330 into a hole or cup 322. Green 300 generally comprises a putting surface 310 having a hole (or cup) 322 marked by a flagstick or pin 320. Putting surface 310 comprises grass that is cut very short so that a golf ball 330 may roll for a long distance. Putting surface 310 may further include various physical contours, such as slopes or grades which are designed to challenge the player in placing the ball 330 into hole 322. Accordingly, a player must account for the physical contours of putting surface 310 when putting ball 330 into hole (or cup) 322.

To accurately provide golf shot parameters (e.g. force and direction information) for putting ball 330 into hole 322, three general pieces of information must be known: (1) the position of ball 330 on green 300; (2) the position of hole 322 on green 300; and (3) the topography of green 300 (e.g. the slope of putting surface 310 between ball 330 and hole 322). The present disclosure enables the quick determination of the required information and the calculation of recommended golf shot parameters in an accurate manner without slowing play.

Additionally, the golfer may be presented with the golfer's historic data relative to hitting similar putts and/or other golfers' historic data relative to hitting similar putts (e.g., historic probability that the golfer can hole the putt from its current position, historic probability of golfers with similar handicaps holing the putt from similar positions, historic probability of professional golfers holing the putt from a similar position, mean distance left by the golfer and/or other golfers from the hole when striking similar putts, best positions for the ball to be left if the putt is mixed based on topography of the green and historical putting data provided by the golfer and other golfers, etc.).

Specifically, the topography of green 300 and the position of hole 322 can be preprogrammed into server system 103 (because the topography should remain constant and the position of hole 322 is changed daily or every other day and can be updated accordingly). However, the position of ball 330 is different for each golfer. Accordingly, ball marker 101 can be used to determine the position of ball 330 on green 300. The determination of the position of ball 330 can be carried out by a satellite-based navigation system. Ball marker 101 can be oriented proximate to ball 330 and position module 201 can be activated to use satellite-based navigation to determine the position of the ball relative to the topography of green 300 and relative to hole 322.

Satellite-Based Navigation

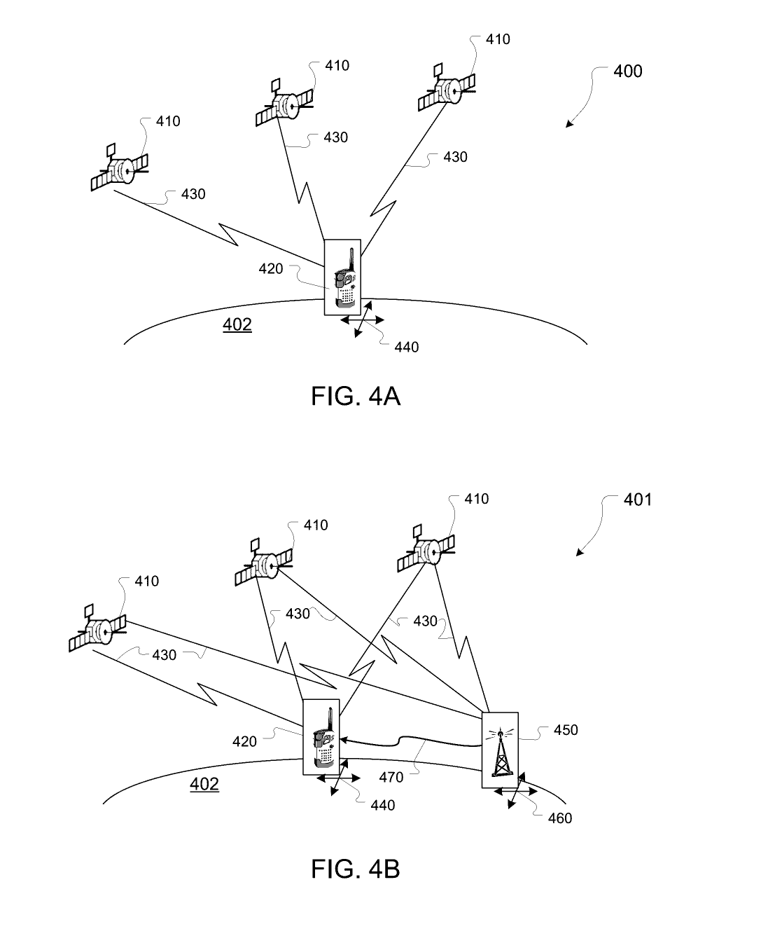

FIG. 4A illustrates an embodiment of a satellite-based navigation system 400. In some embodiments, a satellite-based navigation system 400 can comprise satellites 410 that orbit the Earth 402 and transmit navigation signals 430 that relay the satellites' current time and position. A receiver 420 can receive the transmitted navigation signals 430 and can perform calculations to determine the receiver location 440 of the receiver 420 on Earth 402. In other embodiments, a satellite-based navigation system 400 can comprise a constellation of satellites 410 that are configured to orbit the Earth 402 such that the receiver 420 can receive signals from at least four satellites 410 at any one time. In yet other embodiments, the satellite constellation can comprise additional satellites 410 to increase the number of navigation signals 430 that the receiver 420 can receive to improve the determination of the receiver location 440. In some embodiments, the receiver location 440 can comprise longitude and latitude positions. In other embodiments, the receiver location 440 can comprise altitude positions.

In some embodiments, each satellite 410 can transmit a navigation signal 430 that comprises the orbital data (from which the satellite's position can be calculated) and the precise time that the signal was transmitted. In other embodiments, the navigation signal 430 can comprise a carrier frequency with modulation that includes a known pseudorandom code and a time of transmission. In yet other embodiments, the receiver 420 can calculate a time of flight by aligning the pseudorandom code and comparing the time of transmission to determine a distance to a satellite 410. The receiver 420 can determine the distance to at least four satellites 410 and can use the known positions of the satellites 410 to compute the receiver location 440.

In some embodiments, satellite-based navigation systems 400 can comprise a global navigation satellite system (GNSS) comprising a satellite constellation with global coverage. Global navigation satellite systems can include Global Positioning System (GPS), GLONASS, Galileo, COMPASS/Beidou2, IRNSS, and/or Quasi-Zenith Satellite System (QZSS). In other embodiments, satellite-based navigation systems 400 can include regional satellite navigation systems comprising satellite constellations with regional coverage.

GPS is a United States-sponsored satellite-based navigation system 400 with a constellation of 32 medium Earth orbit satellites. GPS satellites transmit an L1 carrier signal carrying the C/A (civilian access or coarse acquisition) code and the L2 carrier. Newer GPS satellites can also transmit an L2C signal and an L5 signal. GLONASS is a Russian satellite-based navigation system 400 comprising a constellation of 22 satellites. GLONASS satellites transmit two different frequencies for each satellite (frequency division multiple access or FDMA signals). Newer GLONASS satellites can transmit a new CDMA signal called L3 as well as FDMA signals and CDMA signal on L1 and L2 bands. Galileo is a satellite-based navigation system 400 sponsored by the European Union. Galileo satellites can transmit L1 and L5-like signals that are compatible with GPS receivers. Galileo will include an Open Service (OS) that will offer E1 and E5 signals that are similar to L1 and L5. However, the E5 signal resolution will be as much as three times that of GPS L1. China's satellite-based navigation system 400, COMPASS/Beidou2, is a regional system that comprises nine satellites that transmit on four carrier frequency bands. Quasi-Zenith Satellite System (QZSS) is a Japanese-sponsored satellite-based navigation system 400 that provides high elevation satellites to overcome problems with receiving navigation signals in urban canyons. The first QZSS satellite broadcasts L1 and L2C signals with the capacity to broadcast L1C and L5 signals. The QZSS system will comprise additional satellites and become a regional satellite-based navigation system.

In some embodiments, satellite-based navigation systems 400 can further comprise augmentation systems to enhance positioning accuracy and integrity monitoring. In other embodiments, augmentation of satellite-based navigation systems 400 can comprise methods of improving accuracy, reliability, and/or availability by integrating external information into the calculation process. In yet other embodiments, this external information can comprise additional information about sources of error such as clock drift, ephemeris, or ionospheric delay. In some embodiments, augmentation systems can comprise satellite-based augmentation systems (SBAS). SBAS systems can comprise a ground-based control segment which provides corrections between satellite-calculated position determination and actual position. These corrections can be broadcast to geostationary satellites that can then transmit the corrections to receivers. The receivers can then apply the corrections to the satellite-calculated position determination to enhance accuracy of the determined location. In yet other embodiments, SBAS systems can include US Wide Area Augmentation System (WAAS) that broadcasts an extra GPS signal along with the correction signals to achieve differential GPS corrected positioning. In some embodiments, SBAS systems can include EGNOS (European Geostationary Navigation Overlay Service) and Japan's MSAS (Multi-functional Satellite Augmentation System). In some embodiments, satellite-based augmentation systems (SBAS) can comprise wide-area DGPS (WADGPS). In some embodiments, satellite-based augmentation systems (SBAS) can comprise Wide Area GPS Enhancement (WAGE), StarFire navigation system (operated by John Deere), Starfix DGPS System (operated by Fugro), and/or OmniSTAR system (operated by Fugro).

In some embodiments, satellite-based navigation systems 400 can further comprise ground based augmentation systems (GBAS) to enhance positioning accuracy and integrity monitoring. In other embodiments, satellite-based navigation systems 400 can further comprise ground based regional augmentation systems (GRAS) to enhance positioning accuracy and integrity monitoring. GBAS and GRAS systems can comprise a ground-based control segment which provides corrections between satellite-calculated position determination and actual position. These corrections can be broadcast to receivers that apply the corrections to the satellite-calculated position determination to enhance accuracy of the determined location. In yet other embodiments, GBAS and GRAS systems can transmit the corrections through terrestrial radio signals. In some embodiments, GBAS systems can transmit corrections through VHF or UHF bands. In other embodiments, GRAS systems can transmit corrections through VHF bands. In yet other embodiments, GBAS systems can comprise International Civil Aviation Organization, Ground-based Augmentation System, Local Area Augmentation System (LAAS), US Nationwide Differential GPS System (NDGPS), and/or differential GPS (DGPS) systems.

In some embodiments, the satellite-based system may be augmented by precise point positioning (PPP). In PPP, an augmentation system has information on the exact positions and clock errors of satellites 410. This information on the exact positions and clock errors of satellites 410 can be transmitted to receivers 420 to be used to enhance accuracy of the location determination. In other embodiments, this information on the exact positions and clock errors of satellites 410 can be transmitted to receivers 420 via the Internet.

FIG. 4B illustrates an embodiment of a Real Time Kinematic (RTK) satellite-based navigation system 401. In some embodiments, an RTK system 401 can provide enhanced position data as compared to satellite-based navigation systems alone. In other embodiments, RTK systems 401 can comprise satellites 410 that orbit the Earth 402 and transmit navigation signals 430 that relay the satellites' current time and position. In yet other embodiments, a receiver 420 in an RTK system 401 can receive navigation signals 430 from the satellites 410 that comprise a pseudorandom code on a carrier wave. The RTK receiver 420 can use the phase of the carrier wave signal to determine the receiver location 440 of the receiver 420 on Earth 402. In some embodiments, an RTK system 401 can further comprise a base station receiver 450. The precise location 460 of the base station 450 can be determined. The base station 450 can receive navigation signals 430 from the satellites 410 that comprise a carrier wave and measure the phase of the carrier wave signal. The base station 450 can transmit 470 phase measurements of the carrier wave signal to the RTK receiver 420. In some embodiments, the RTK receiver 420 can compare the base station phase measurements with the RTK receiver phase measurements to determine the position 440 of the RTK receiver 420. In other embodiments, the RTK receiver 420 can determine the position 440 of the RTK receiver 420 by comparing the base station phase measurements with the RTK receiver phase measurements and by using the precise location 460 of the base station 450. In some embodiments, the base station 450 can transmit 470 phase measurements of the carrier wave signal to the RTK receiver 420 with low power spread-spectrum radio signals, UHF/VHF radio signals, GSM/CDMA phone network signals, and/or RTK network signals. In other embodiments, the base station 450 can transmit 470 phase measurements of the carrier wave signal to the RTK receiver 420 via the Internet.

In yet other embodiments, an RTK system 401 can determine the position 440 of the RTK receiver 420 to within 30 cm. In some embodiments, an RTK system 401 can determine the position 440 of the RTK receiver 420 to within 10 cm. In other embodiments, an RTK system 401 can determine the position 440 of the RTK receiver 420 to within 5 cm. In other embodiments, an RTK system 401 can determine the position 440 of the RTK receiver 420 to within 2 cm. In other embodiments, an RTK system 401 can determine the position 440 of the RTK receiver 420 to within 1 cm. In other embodiments, an RTK system 401 can determine the position 440 of the RTK receiver 420 to within 4 mm.

In some embodiments, an RTK system 401 can determine the position of the ball 330 to within 30 cm. In other embodiments, an RTK system 401 can determine the position of the ball 330 to within 10 cm. In yet other embodiments, an RTK system 401 can determine the position of the ball 330 to within 5 cm. In some embodiments, an RTK system 401 can determine the position of the ball 330 to within 2 cm. In other embodiments, an RTK system 401 can determine the position of the ball 330 to within 1 cm. In other embodiments, an RTK system 401 can determine the position of the ball 330 to within 4 mm. In yet other embodiments, the RTK system 401 can determine the position of the ball 330 relative to the base station 450 with enhanced accuracy compared to determining the absolute position of the ball 330 on Earth 402. In some embodiments, determining the position of the ball 330 relative to the base station 450 can be more effective for determining recommended golf shot parameters because the position of the base station 450 relative to the green 300 and the hole 322 can be known.

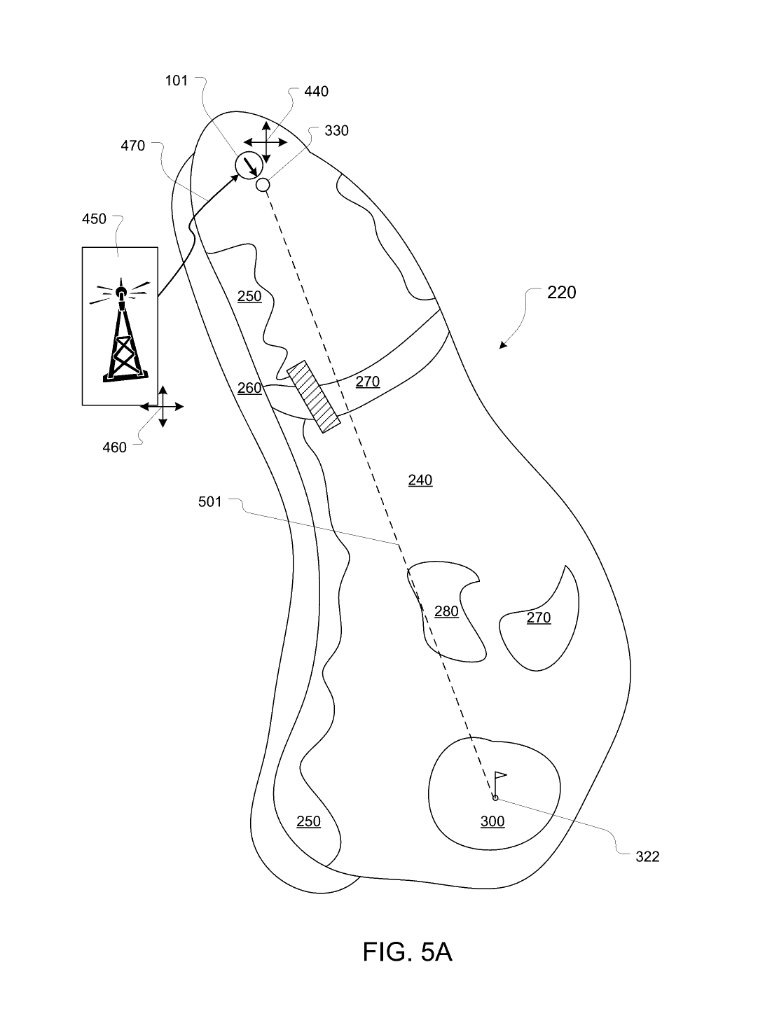

FIG. 5A illustrates a perspective view of golf course hole 220 to describe how ball marker 101 uses position module 201 to determine the position of ball 330 relative to the golf course hole 220 and relative to the position of the hole 322 during striking the ball 330 to the green 300 or desired position in the fairway 230. In some embodiments, ball marker 101 can include an indication for orienting the ball marker in the appropriate position proximate to the ball 330. The line 501 defines a straight path between the ball 330 and the hole 322. The ball marker 101 can be appropriately oriented proximate to the ball 330 and the ball marker 101 can be activated to determine the position of the ball 330. In some embodiments the ball marker 101 can be activated by activating positioning module 201 to determine the position of the ball 330. In other embodiments, a button or switch on the ball marker 101 can be activated to activate the positioning module 201. In yet other embodiments, the ball marker 101 can be activated by the mobile computing device 102. In some embodiments, the ball marker 101 can be held over the ball 330 while being activated. In other embodiments, the ball marker 101 can be on the golfer's person while being activated. In yet other embodiments, the ball marker 101 can be attached to and/or integrated into a golf club.

In some embodiments, the positioning module 201 can determine the position of the ball 330 by Real Time Kinematic satellite-based navigation. The positioning module 201 can comprise an RTK receiver 420 configured to receive navigation signals 430 from a constellation of satellites 410. In other embodiments, the positioning module 201 can receive navigation signals 430 from the satellites 410 that comprise a pseudorandom code on a carrier wave. The positioning module 201 can use the phase of the carrier wave signal to determine the location 440 of the ball 330 on the golf course hole 220. In some embodiments, a base station 450 can be used by positioning module 201 to determine the position of the ball 330. The precise location 460 of the base station 450 can be determined. The base station 450 can receive navigation signals 430 from the satellites 410 that comprise a carrier wave and measure the phase of the carrier wave signal. The base station 450 can transmit 470 phase measurements of the carrier wave signal to the ball marker 201. In some embodiments, the ball marker 101 can compare the base station phase measurements with the positioning module 201 phase measurements to determine the position 440 of the ball 330. In other embodiments, the ball marker 101 can determine the position 440 of the ball marker 101 by comparing the base station phase measurements with the positioning module 201 phase measurements and by using the precise location 460 of the base station 450.

In some embodiments, the base station 450 can be located on the golf course relative to a known, fixed landmark such as a sprinkler head. In other embodiments, the base station 450 can be provided by the golfer and can be affixed to a known, fixed landmark before beginning play and remain in the fixed location during play. In yet other embodiments, the base station 450 can be provided by the golfer and affixed to a known, fixed landmark at each golf course hole 220. In some embodiments, a plurality of base stations 450 can employed at multiple locations throughout the golf course. In other embodiments, the plurality of base stations 450 can be part of a private or public network of base stations outside of a golf course. In yet other embodiments, the private or public network of base stations can include Trimble VRS, Leica Spider, single baseline (Plate Boundary Observatory and CRTN), and Topcon Topnet. In some embodiments, the ball marker 101 can be configured to be compatible with base station 450 of the system and other private or public base stations. In other embodiments, the ball marker 101 can be configured to switch between multiple base stations 450 of the system and base stations of other private or public networks.

In some embodiments, the ball receiver 101 can use positioning module 201 to determine the ball position based on a satellite-based navigation system 400 without RTK. In other embodiments, the ball receiver 101 can use positioning module 201 to determine the ball position based on satellite-based augmentation systems (SBAS). In yet other embodiments, the ball receiver 101 can use positioning module 201 to determine the ball position based on wide-area DGPS (WADGPS). In some embodiments, the ball receiver 101 can use positioning module 201 to determine the ball position based on ground based augmentation systems (GBAS). In other embodiments, the ball receiver 101 can use positioning module 201 to determine the ball position based on ground based regional augmentation systems (GRAS). In yet other embodiments, the ball receiver 101 can be used positioning module 201 to determine the ball position based on International Civil Aviation Organization, Ground-based Augmentation System, Local Area Augmentation System (LAAS), US Nationwide Differential GPS System (NDGPS), and/or differential GPS (DGPS) systems. In some embodiments the ball receiver 101 can use positioning module 201 to determine the ball position based on PPP.

In some embodiments, the golfer can place the ball marker 101 behind the golf ball 330 and can activate the ball marker 101. In other embodiments, a golfer may retain the ball marker 101 on his or her person and activate the ball marker 101 so that activating the ball marker 101 does not require any additional time than would otherwise be taken by the golfer. In yet other embodiments, the ball marker 101 can be integrated into mobile computing device 102. In some embodiments, the player may desire to determine the position of the ball 330 with more accuracy and will place the ball marker 101 on a surface proximate to the ball 330 to determine the position of the ball 330. In other embodiments, the player may only desire an estimate of the position of the ball 330 and may activate the ball marker 101 while holding the ball marker over the ball 330. In yet other embodiments, during parts of play such as driving, the precise position of the ball 330 is less important to determining recommended golf shot parameters. In some embodiments, the player may desire to speed play and may activate ball marker 101 while ball marker 101 is on player's person or while holding ball marker 101 over the ball 330. Because ball marker 101 can provide recommended club selection, force, and direction information for striking the ball, which the typical golfer would otherwise spend a significant amount of time determining mentally, the use of ball marker 101 may not slow play, and in many cases may even speed play.

In some embodiments, ball marker 101 can inform the golfer approximately how hard the ball should be hit and the approximate direction to aim, providing the golfer with recommendations for holing the putt, recommendations for the best “leave” (i.e., the best position for the ball to be in should the golfer hiling miss the putt with shot stroke), the probabilility of successfully executing the shot based on the golfer's historic data and/or others golfers' historic data, weather conditions at the time, level of difficulty in executing the putt, etc. In other embodiments, the ball marker 101 can provide a recommended club selection to the golfer. In other embodiments, the system may provide the golfer with two or more recommended golf club selections with a recommended type of shot to be hit (e.g. a “fade,” a “draw,” a “punch-shot,” a “knock-down” shot, etc.) and probability of successfully excetuing the shot based on a variety of factors including but not limited to: the golfer's historic shot making data, other golfers' historic shot making data, weather, wind velocity, wind direction, distance of shot, etc. In yet other embodiments, the ball marker 101 can inform the golfer of the location of hazards on the golf course hole 220. In some embodiments, the ball marker 101 can inform the golfer of other environmental conditions on the golf course hole 220. This information can be determined and returned immediately by server system 103 for display on ball marker 101 thereby relieving the golfer from having to spend the time to figure out this information on his own. The golfer only needs to view the information on ball marker 101 and play the selected shot accordingly. In other embodiments, the server system 103 can display this information on the mobile computing device.

In some embodiments, the ball marker 101 determines the position of the ball 330 on the golf course hole 220 by using the positioning module 201. The position of the ball 330 can then be transmitted to the server system 103 by the communication module 203. Using this position in combination with the known position of the hole 322, the topography of the fairway 230, the known position of hazards, any relevant environmental factors, a player's past history of play, server system 103 can calculate the approximate amount of force with which the ball 330 should be hit, the approximate direction to hit the ball 330, the club(s) the golfer should consider using, and the type(s) of shot(s) the golfer should consider executing. Server system 103 can also recommend a particular club and/or multiple clubs, and/or short types the golfer should consider using. For example, the server system 103 can determine that the hole 322 is 210 yards away from the ball 330, and that there is a slight easterly wind on the golf course hole 220. The server system can also determine that according to the player's past history of play, that the player averages 210 yards with a 5-wood club. Server system 103 can therefore recommend selecting the 5-wood, the direction that the drive should be hit to compensate for the wind and other factors, the force, and the locations of any potential hazards that need to be avoided. Alternatively, the server could recommend using a 3-wood struck at less than full force producing a lower ball flight, which would be less affected by the wind, effectively increasing the probability that the golfer could make club recommendations hard on whether the golfer typically fades or draws the ball, effectively increasing or decreasing the force the ball will need to be struck with given the particular wind conditions. Additionally, the server system may provide the golfer with multiple club, ball-flight, and force options to choose from, each suggested with their relative probability of successfully executing the recommended shot given the current conditions and the golfer's historic striking data.

FIG. 5B illustrates a perspective view of green 300 to describe how ball marker 101 uses position module 201 to determine the position of ball 330 relative to the green 300 and relative to the position of the hole 322. The line 503 defines a straight path between the ball 330 and the hole 322. The ball marker 101 can be placed proximate to the ball 330 and the ball marker 101 can be activated to determine the position of the ball 330. In some embodiments the ball marker 101 can be activated by activating positioning module 201 to determine the position of the ball 330. In other embodiments, a button or switch on the ball marker 101 can be activated to activate the positioning module 201. In yet other embodiments, the ball marker 101 can be activated by the mobile computing device 102. In some embodiments, the ball marker 101 can be held over the ball 330 while being activated. In other embodiments, the ball marker 101 can be on the golfer's person while being activated. In yet other embodiments, the ball marker 101 can be attached to and/or integrated into a golf club. Although FIG. 5 shows ball 330 being left on the putting surface 310 during the placement and activation of ball marker 101, in some embodiments, ball 330 can be picked up after being marked by ball marker 101.

In some embodiments, the positioning module 201 can determine the position of the ball 330 by Real Time Kinematic satellite-based navigation. The positioning module 201 can comprise an RTK receiver 420 configured to receive navigation signals 430 from a constellation of satellites 410. In other embodiments, the positioning module 201 can receive navigation signals 430 from the satellites 410 that comprise a pseudorandom code on a carrier wave. The positioning module 201 can use the phase of the carrier wave signal to determine the location 440 of the ball 330 on the green 300. In some embodiments, a base station 450 can be used by positioning module 201 to determine the position of the ball 330. The precise location 460 of the base station 450 can be determined. The base station 450 can receive navigation signals 430 from the satellites 410 that comprise a carrier wave and measure the phase of the carrier wave signal. The base station 450 can transmit 470 phase measurements of the carrier wave signal to the ball marker 201. In some embodiments, the ball marker 101 can compare the base station phase measurements with the positioning module 201 phase measurements to determine the position 440 of the ball 330. In other embodiments, the ball marker 101 can determine the position 440 of the ball marker 101 by comparing the base station phase measurements with the positioning module 201 phase measurements and by using the precise location 460 of the base station 450.

In some embodiments, the base station 450 can be located on the golf course relative to a known, fixed landmark such as a sprinkler head. In other embodiments, the base station 450 can be provided by the golfer and can be affixed to a known, fixed landmark before beginning play and remain in the fixed location during play. In yet other embodiments, the base station 450 can be provided by the golfer and affixed to a known, fixed landmark at each green 300. In some embodiments, a plurality of base stations 450 can employed at multiple locations throughout the golf course. In other embodiments, the plurality of base stations 450 can be part of a private or public network of base stations outside of a golf course. In yet other embodiments, the private or public network of base stations can include Trimble VRS, Leica Spider, single baseline (Plate Boundary Observatory and CRTN), and Topcon Topnet. In some embodiments, the ball marker 101 can be configured to be compatible with base station 450 of the system and other private or public base stations. In other embodiments, the ball marker 101 can be configured to switch between multiple base stations 450 of the system and base stations of other private or public networks.

In some embodiments, the ball receiver 101 can use positioning module 201 to determine the ball position based on a satellite-based navigation system 400 without RTK. In other embodiments, the ball receiver 101 can use positioning module 201 to determine the ball position based on satellite-based augmentation systems (SBAS). In yet other embodiments, the ball receiver 101 can use positioning module 201 to determine the ball position based on wide-area DGPS (WADGPS). In some embodiments, the ball receiver 101 can used positioning module 201 to determine the ball position based on ground based augmentation systems (GBAS). In other embodiments, the ball receiver 101 can used positioning module 201 to determine the ball position based on ground based regional augmentation systems (GRAS). In yet other embodiments, the ball receiver 101 can be used positioning module 201 to determine the ball position based on International Civil Aviation Organization, Ground-based Augmentation System, Local Area Augmentation System (LAAS), US Nationwide Differential GPS System (NDGPS), and/or differential GPS (DGPS) systems. In some the ball receiver 101 can be used positioning module 201 to determine the ball position based on PPP.

In some embodiments, the golfer can place the ball marker 101 behind the golf ball 330 and can activate the ball marker 101. Typically, a golfer is required to mark his ball on the green with some type of ball marker, and therefore, placing ball marker 101 behind ball 330 and activating the ball marker 101 does not require any additional time than would otherwise be taken by the golfer. Because ball marker 101 can provide recommended force and direction information for putting the ball, which the typical golfer would otherwise spend a significant amount of time determining mentally, the use of ball marker 101 may not slow play, and in many cases may even speed play.

In some embodiments, ball marker 101 can inform the golfer approximately how hard the putt should be hit, the approximate direction to aim, the best position to “leave” the ball in if the putt is missed, the probability of holing the putt, and/or the average distance from holing the putt the golfer should expect given the golfer's historic data, weather conditions, and/or historic performance data of similar golfers who have putted the ball from a similar position. This information can be determined and returned immediately by server system 103 for display on ball marker 101 thereby relieving the golfer from having to spend the time to figure out this information on his own. The golfer only needs to view the information on ball marker 101, select the shot type, and play the shot accordingly.

In some embodiments, the ball marker 101 determines the position of the ball 330 on the green 300 by using the positioning module 201. The position of the ball 330 on the green can then be transmitted to the server system 103 by the communication module 203. Using this position in combination with the known position of the hole 322 and the topography of the green 300, server system 103 can calculate the approximate amount of force with which the ball 330 should be hit, and the approximate direction to hit the ball 330. For example, based on the topography of the green 300 between the position of the ball 330 and the hole 322, server system 103 can determine that the hole 322 is four feet uphill from the ball 330 and that there is a rightward slope of 10 degrees. Server system 103 can therefore recommend hitting the ball x feet to the left of the hole (to account for the break to the right) and with a force y (to account for the uphill slope).

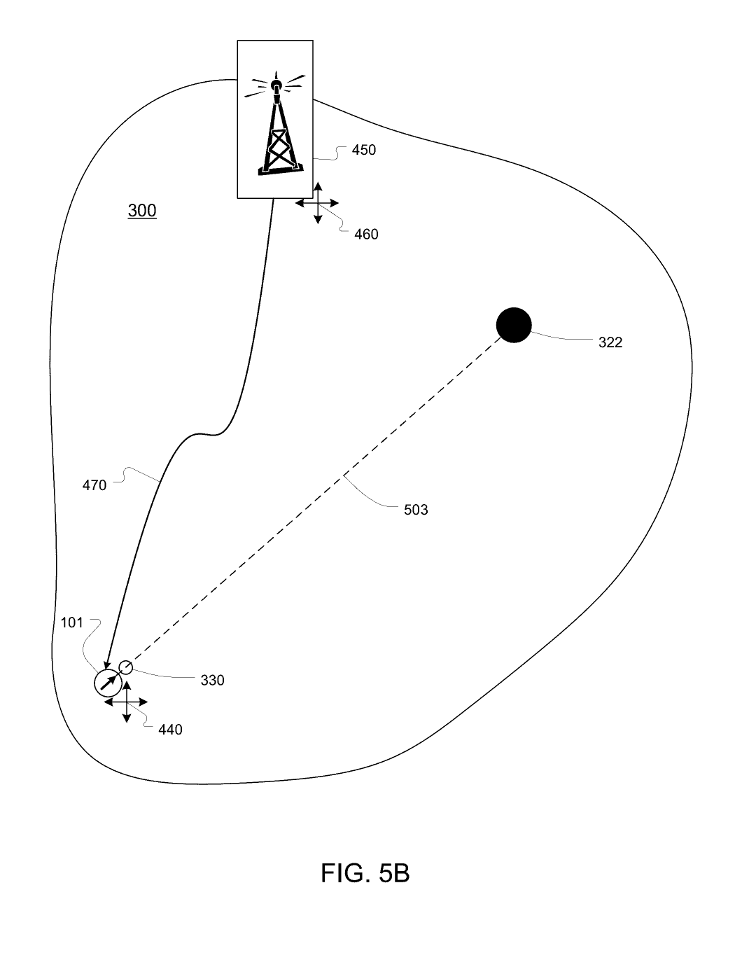

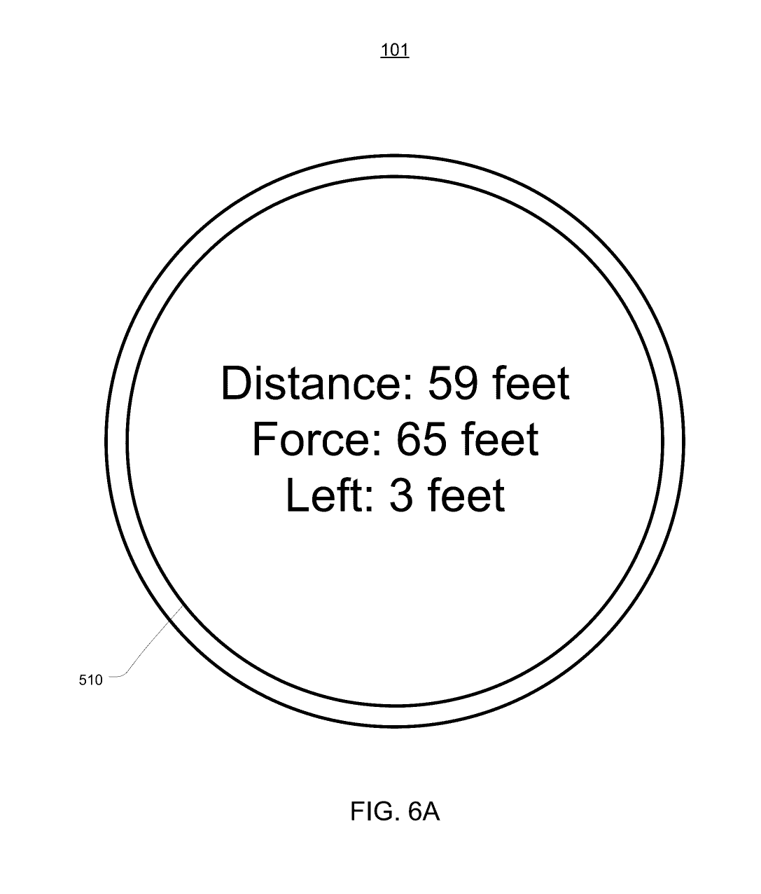

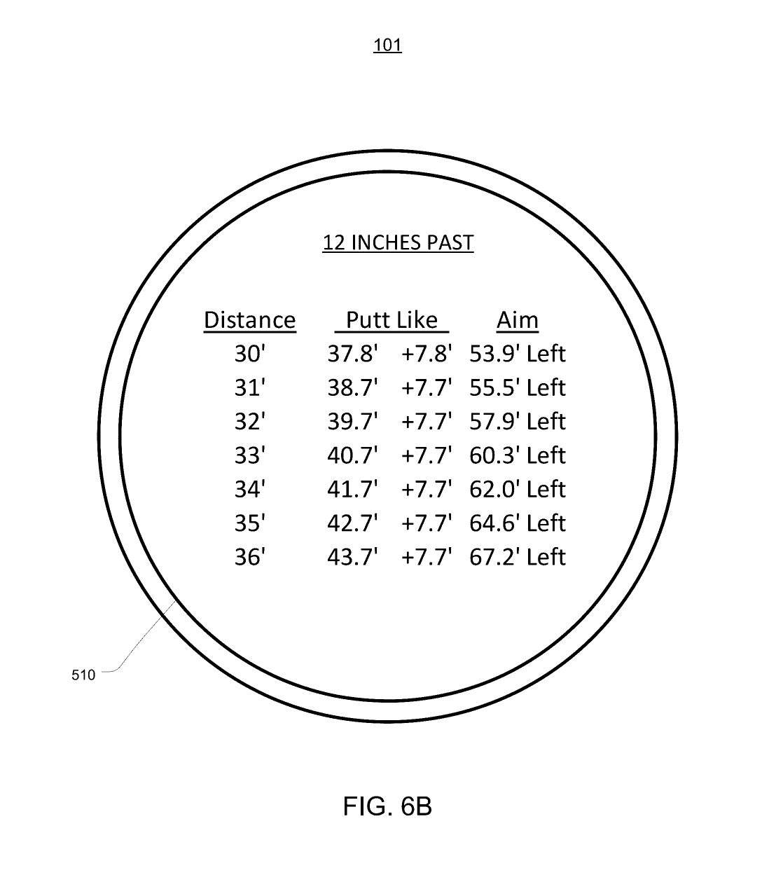

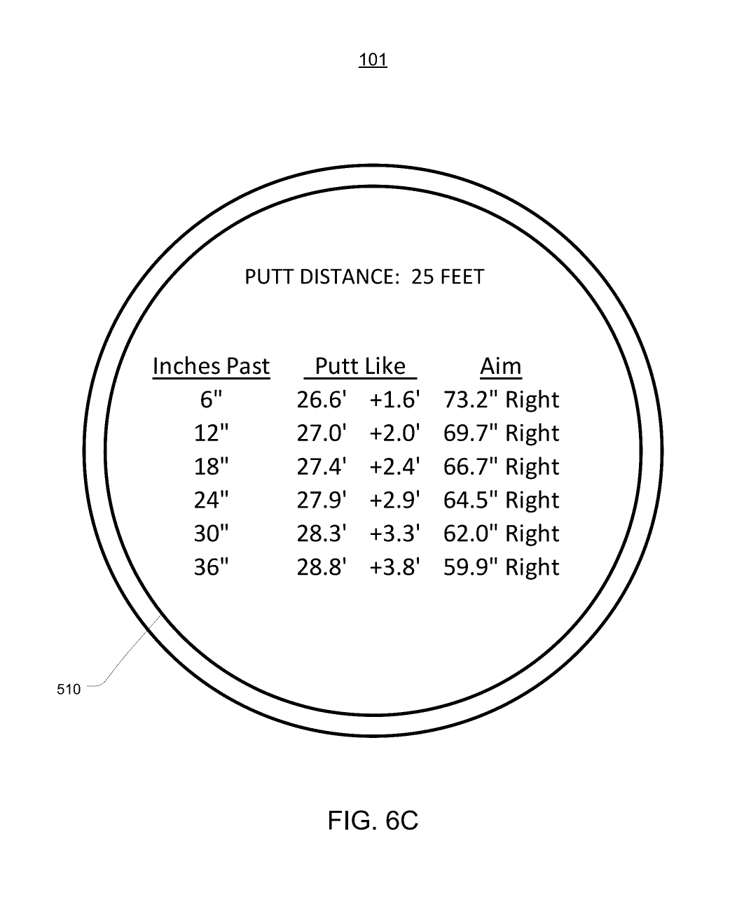

FIG. 6A illustrates an exemplary display of recommended force and direction information on ball marker 101 using the example numbers from the previous paragraph. As shown, given determined distance of 59 feet to the hole and the other known parameters, server system 103 has recommended that the putt be hit with a force of 65 feet (i.e. with a force that would result in the ball moving 65 feet over a flat green) and at 3 feet to the left of the hole 322.

In some embodiments, server system 103 can also provide recommended force and direction information for other distances around the determined distance. For example, server system 103 can calculate recommended force and direction information for distances of 56, 57, 58, 60, 61, and 62 feet using the same determined angle. FIG. 6B illustrates an exemplary display that includes recommended golf shot parameters for multiple distances. The number of distances for which golf shot parameters are recommended can be a user configurable parameter or may vary based on the topography of the green.

In this way, the golfer can easily see if a change in the determined distance will result in a significant change in the recommended shot. For example, if a significant break existed at 60 feet from the hole but not at 58 feet from the hole (as shown in FIG. 6B by the 11″ difference between the recommended aim for 58′ and 60′), the golfer could see the significant difference between recommended force/distance information and adjust his or her shot accordingly. However, if the force/distance information changed essentially linearly with the determined distance, the golfer need not be too concerned that following recommended information for the wrong distance will give undesirable results.

In other embodiments, the servers system 103 can also provide golf shot parameters for a given putt that includes various amounts of force with which the ball 330 should be hit to have the ball stop at a given distance past the hole 322 with the various amounts of force being equivalent to the force necessary to move the ball 330 that distance over a flat green. For example, server system 103 can calculate recommended force and direction information for distances of 6, 12, 18, 24, 30, and 36 inches past the hole. FIG. 6C illustrates an exemplary display that includes recommended golf shot parameters for multiple distances past the hole. For example, FIG. 6C illustrates golf shot parameters for a putt distance of 25 feet. FIG. 6C also shows the amount of inches past the hole 322, the amount of force needed, and the aim. Although FIGS. 6A, 6B, and 6C illustrate golf shot parameters displayed on ball marker 101, in other embodiments, the golf shot parameters of FIGS. 6A, 6B, and 6C can be displayed on mobile computing device 102. In yet other embodiments, the golf shot parameters of FIGS. 6A, 6B, and 6C can be available through a website. In some embodiments, the golf shot parameters of FIGS. 6A, 6B, and 6C can be available in an audio format.

In some embodiments, the slope of the position of the ball 330 can be determined by comparing the ball position as determined by the position module 201 with topographical data. By determining the horizontal and vertical position of the ball 330 in relation to the topographical data, the slope at the corresponding point in the topographical data can be ascertained. This slope data of the position of the ball can then be used by the server system to determine golf shot parameters. In other embodiments, the slope of the position of the ball 330 can be determined by the slope module 204 and can be used by the server system to determine golf shot parameters. In yet other embodiments, the slope of the position of the ball 330 can be determined by position module 201 and slope module 204. In some embodiments, the server system 103 can determine golf shot parameters based on slope data from position module 201 and/or slope module 204. In other embodiments, the slope adjusted golf shot parameters can be displayed to the golfer. In yet other embodiments, the slope adjusted golf shot parameters and the non-slope adjusted golf shot parameters can be displayed to the golfer. In some embodiments, the system can display both slope adjusted and non-slope adjusted golf shot parameters to the golfer. In other embodiments, the system can display both slope adjusted and non-slope adjusted golf shot parameters to the golfer for all relevant distances including distance to rough 250, out of bounds 260, water obstacles 270, sand traps 280, and other similar distances. In yet other embodiments, the slope adjusted golf shot parameters can include a single and/or multiple golf club recommendations.

In some embodiments, displaying the slope adjusted golf shot parameters can enhance learning by the golfer. For example, by providing the golfer with slope adjusted golf parameters including a single and/or multiple club selection(s), the golfer can improve in his or her ability to determine similar golf shot parameters based on his or her own skills, including the ability to select an appropriate club and/or recognize alternative club and/or shot selections. In other embodiments, displaying the slope adjusted golf shot parameters and the non-slope adjusted golf shot parameters can enhance learning by the golfer. For example, by providing the golfer with both the slope adjusted golf parameters and the non-slope adjusted parameters including club selection, the golfer can improve in his or her ability to determine similar golf shot parameters based on his or her own experience, skill, intuition or other similar factors. In yet other embodiments, displaying the slope adjusted golf shot parameters can speed play. In some embodiments, displaying the slope adjusted golf shot parameters can speed play by aiding the golfer in the selection of an appropriate club. In other embodiments, displaying the slope adjusted golf shot parameters can speed play by reducing the time a golfer spends on determining golf shot parameters he or she should use for the shot.

Variations in the Employed Computing Environment

The above described embodiments are generally preferred because they minimize the chance that the disclosed methods and systems will slow the rate of play. However, the disclosed methods and systems can also be implemented with other variations.

For example, in some embodiments, ball marker 101 may not comprise display capabilities. In such cases, mobile computing device 102 can be used to activate the ball marker 101 and to display the recommended golf shot parameters and/or alternative golf shot parameters to the golfer. Ball marker 101 can include positioning module 201 that determines a ball position as described above and communication module 203 that relays this position to mobile computing device 102. Accordingly, in such embodiments, the ball marker is placed in the same manner as described above, but the golfer is required to interface with mobile computing device 102 to activate the ball marker 101 and to view recommended golf shot parameters. In some embodiments, the function of the ball marker 101 and the mobile computing device 102 can be integrated into one device. In other embodiments, the ball marker 101 can be configured to be attached to the mobile computing device 102. In yet other embodiments, the ball marker 101 can be configured as an accessory that can be detachably coupled to the mobile computing device 102.

Also, even in embodiments as described above where the ball marker includes activation and display capabilities, the golfer may choose to use either ball marker 101 or mobile computing device 102 to provide input and to view recommended golf shot parameters. Using mobile computing device 102 may be less desirable because it may tend to slow the rate of play. For example, if the golfer is removing his or her cell phone from his or her pocket each time he or she desires to input shot information or to view recommendation information, it may slow play.

In other embodiments, ball marker 101 can include functionality so that a separate mobile computing device 102 is not required. In such cases, ball marker 101 can include functionality to directly communicate with server system 103. For example, ball marker 101 can communicate directly over a mobile data network, a Wi-Fi network, or another type of network providing direct internet access to server system 103. In some embodiments, a golf course may desire to place routers or other access points within proximity of a green to allow ball marker 101 to use Wi-Fi communications to transfer information to and receive information from server system 103. Of course, other communication protocols could also be used in a similar manner.

In further embodiments, it is also possible that ball marker 101 or mobile computing device 102 contain sufficient processing power and storage to perform the functions of server system 103 described above. In such cases, ball marker 101 (or ball marker 101 in communication with mobile computing device 102) would not need to communicate with any other computing device, but could calculate recommended golf shot parameters using stored hole location, topography information, and historic golfer information in conjunction with a determined ball position.

In some embodiments, the golfer places the ball marker 101 proximate to the ball 330 and activates the ball marker 101 by pressing a button on the ball marker 101 to calculate and communicate position information to the mobile computing device 102. The mobile computing device 102 receives the position information and the computer of the mobile computing device 102 acts as the server system 103 to calculate the golf shot parameters. The mobile computing device 102 can further comprise a smartphone application that can be configured to interface with the golfer. The smartphone application can be configured to receive input data from the golfer and to display the calculated recommended golf shot parameters.

Other Parameters Usable in Calculating Golf Shot Parameters

When calculating the optimal ball striking or putt swing speed, it may be desirable to compensate for the weight or “mass” of the golfer's club or putter, brand, and/or type of the golfer's clubs, putter, and/or ball. Accordingly, in some embodiments, ball marker 101 and/or mobile computing device 102 further comprises an input field where the golfer is prompted to enter a value which indicates the mass of the golfer's club or putter (e.g. by directly inputting the mass, by inputting the putter model, etc.), the brand and/or model of the golfer's clubs, and/or the brand and/or type of the golf ball bags sued by the golfer.

Ball marker 101 and/or mobile computing device 102 can also be configured to determine or receive other variable parameters that may affect a drive or a putt such as wind speed, grass length, humidity, etc. In some embodiments, one or more of these additional parameters can be reported to server system 103 and used in the calculation of the recommended golf shot parameters. In other embodiments, a separate device can be configured to determine these variables and report them to server system 103. In yet other embodiments, the ball marker 101 or the mobile computing device can be configured such that a player can input these variables.

Database for Storing Drive and Putt Data

In some embodiments, the systems of the present disclosure further include a user database which is configured to record and store ball striking and putt data for each of the clubs used by the golfer, the types of shots the golfer is capable of hitting, the consistence with which the golfer hits certain clubs or shots types, and other calculations determined by ball marker 101 and mobile computing device 102 during the golfer's round of golf. For example, in some embodiments information received and calculated by ball marker 101 and/or mobile computing device 102 is uploaded to a database which is made available to the golfer for subsequent analysis and record-keeping. This data may be compared with data of other golfers of particular demographics (e.g., of similar ability, golfers of similar age, etc.). For example, a golfer may be required to register or subscribe to a database service to gain access to the golfer's drive and putt data. Alternatively, mobile computing device 102 may include a database software application which is configured to automatically store and update the golfer's drive and putt data in real-time. Further still, in some instances a database is provided which is part of a social network where the golfer's drive data (e.g. club selection, length of drive, location of ball, number of strokes) and putt data (e.g. the length of putts and ball orientation) is posted and made available for public viewing, comparison, and comment. The golfer's putt data may further be updated to a community website that is provided for tracking a golfer's progress or activity. The golfer's drive and putt data may further include a topographical image of golf course hole 220 or green 300, thereby providing a visual representation of the golfer's drive and putt data.

In some embodiments, mobile computing device 102 (or server system 103) analyzes the golfer's drive and putt data to learn golf course hole 220 and green 300 and thereby modify drive and putt instructions based upon the precise position of a ball. Thus, mobile computing device 102 (or server system 103) comprises learning capabilities. In some embodiments, the learning capabilities of mobile computing device 102 further analyze and learn the mechanics or tendencies of the golfer's given swing with each club and thereby modify the ball striking and putting instructions to compensate for the golfer's style and/or skills.

In some embodiments, the systems and devices of the present disclosure are further used in combination with a swing speed trainer, which is designed to assist the golfer in learning and/or adjusting his swing speed for putting. A swing speed trainer may include a software application and hardware which analyzes a golfer's golf swing, and swing speed in real-time during the golfer's putting practice swings. For example, in some instances a swing speed trainer is provided having portable hardware for following the golfer's putter swing using six degrees of freedom to detect detailed results of each putter stroke in real-time, supplying feedback if a given putting stroke is ideal for the putt the golfer is facing (e.g., allowing the golfer to take several practice swings to acquire a “feel” for how firmly the ball needs to be struck). Additionally, the swing speed trainer may provide the golfer with practice swing information such as the degree to which the given swing was open, closed, forward of the putter sweet spot, behind the sweet spot, lofted or de-lofted. Then the same information is collected for the actual putt and later compared to the practice swings. This information may be used in combination with the information derived by ball marker 101 and mobile computing device 102 to provide the golfer with accurate and personalized ball line and swing speed values to assist the golfer in taking future putting strokes.

Topography and Hole Location

In some embodiments, the server system 103 can further comprise a topographical data set. In other embodiments, the topographical data set can comprise the topography of selected greens of a golf course. In yet other embodiments, the topographical data set can comprise the topography of all the greens on a golf course. In some embodiments, the topographical data set can comprise the topography of greens, fairways, holes, and obstacles including waterways, sand traps and/or other obstacles. In some embodiments, the topographical data set can be predetermined and loaded into the server system 102. In other embodiments, the topographical data set can include fixed, known reference points such as base station transmitters 450, sprinkler heads, pathways, markers, and/or landmarks. In yet other embodiments, the topographical data set can be determined by standard surveying techniques such as land surveying. In some embodiments, the topographical data set can be determined as a topographic survey and/or as a contour plot. In other embodiments, the topographical data set can be determined by Real Time Kinematic satellite-based navigation means. In yet other embodiments, the topographical data set can be determined by LIDAR technology. In some embodiments, the topographical data set can be determined with aerial mapping, aerial photographs, satellite mapping, satellite photographs, and/or web mapping services delivered by geographical information systems (GIS) such as NavTeq, Google Maps, MapQuest, and similar web mapping services. In other embodiments, the topographical data set can include any other information about the golf course that may be pertinent such as type of grass on the fairways or greens, position of the sun based on season and time of day, common wind patterns, amount of rain received by the golf course, level of moisture retained by the green, location of holes and other landmarks, wetness and/or dryness of the grass, length of the grass, grain of the grass and any other such information.

Golf courses often change the hole location on the greens. Therefore, each time a hole location is moved, it is necessary to update the known hole location used by server system 103. This can be accomplished in various ways.

In some embodiments, when the topography of the green is determined, the location of one or more fixed features (e.g. sprinkler heads) around the green can be determined and stored with the topography information. Then, each time a new hole location is selected, a tripod (or similar device) can be placed over top of the fixed feature and used to identify the precise location of the new hole location.

The determination of the new hole location can be performed in a similar manner as described above with respect to determining the position of the ball on the green. That is to say, the tripod can contain an RTK module (similar to positioning module 201) that determines the position of the hole 322 in similar fashion as ball marker 101 determines ball position. The determined hole position can be uploaded to server system 103. In some embodiments, the ball marker 101 can be used to determine the position of new holes.

In some embodiments, the golf course can be provided with the option to update the hole location using any of the above described approaches. In such cases, the tripod or other device used to submit the determined positions to server system 103 can include the ability to specify which locations (e.g. fixed feature, old hole, or new hole locations) were determined.

In summary, a ball marker is disclosed that can be used to submit ball location to a server system in a quick and efficient manner thereby allowing the quick provision of golf shot parameter recommendations so that the pace of play is not slowed. The disclosed ball marker can therefore provide additional enjoyment to the game of golf by assisting golfers to be more proficient drivers and putters.

Method for Generating Recommended Golf Shot Parameters for Putting

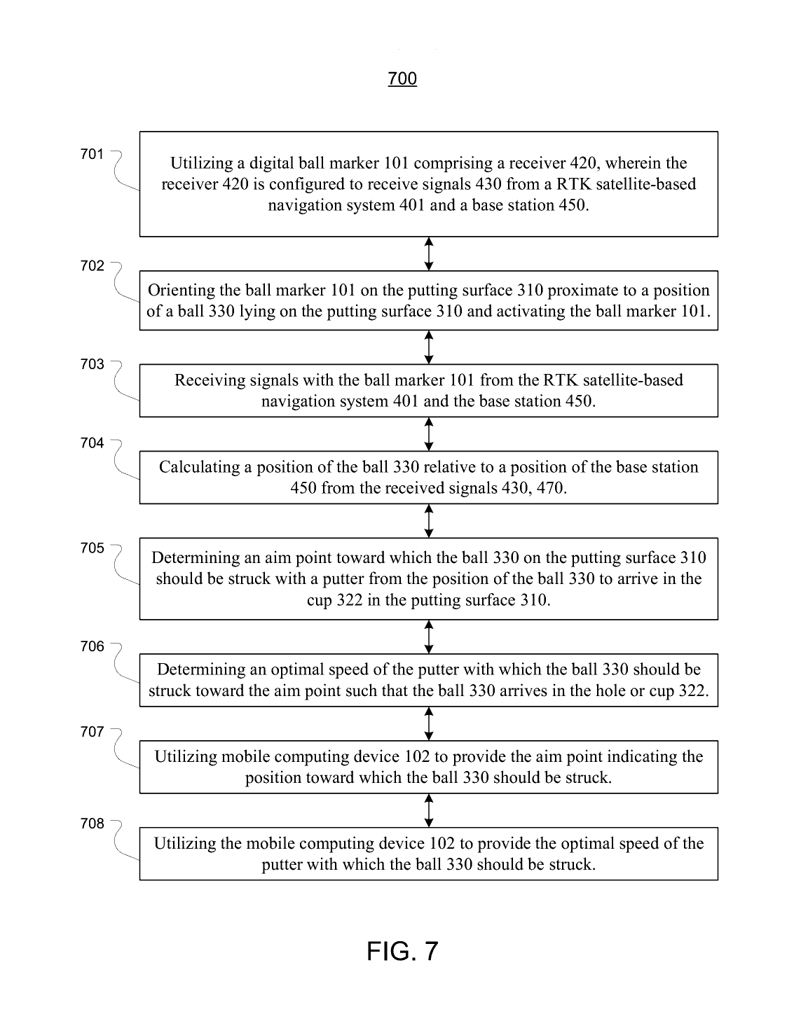

FIG. 7 illustrates a flowchart of an exemplary method 700 for generating recommended swing parameters for putting a golf ball 330 on a green 300. Method 700 can be implemented by a mobile computing device such as a golfer's smartphone or other device carried by the golfer.

In some embodiments, method 700 can comprise a step 701 of utilizing a digital ball marker 101 comprising a receiver 420, wherein the receiver 420 is configured to receive signals 430 from a RTK satellite-based navigation system 401 and a base station 450. In other embodiments, method 700 can comprise a step 702 of orienting the ball marker 101 on the putting surface 310 proximate to a position of a ball 330 lying on the putting surface 310 and activating the ball marker 101. In yet other embodiments, method 700 can comprise a step 703 of receiving signals with the ball marker 101 from the RTK satellite-based navigation system 401 and the base station 450. In other embodiments, method 700 can comprise a step 704 of calculating a position of the ball 330 relative to a position of the base station 450 from the received signals 430, 470. In other embodiments, method 700 can comprise a step 705 of determining an aim point toward which the ball 330 on the putting surface 310 should be struck with a putter from the position of the ball 330 to arrive in the cup 322 in the putting surface 310. For example, the server system 103 can determine the aim point. In other embodiments, method 700 can comprise a step 706 comprising determining an optimal speed of the putter with which the ball 330 should be struck toward the aim point such that the ball 330 arrives in the hole or cup 322. For example, the server system 103 can determine the optimal speed. In other embodiments, method 700 can comprise a step 707 of utilizing mobile computing device 102 to provide the aim point indicating the position toward which the ball 330 should be struck. In other embodiments, method 700 can comprise a step 708 of utilizing the mobile computing device 102 to provide the optimal speed of the putter with which the ball 330 should be struck.

Method for Generating Recommended Golf Shot Parameters for Driving

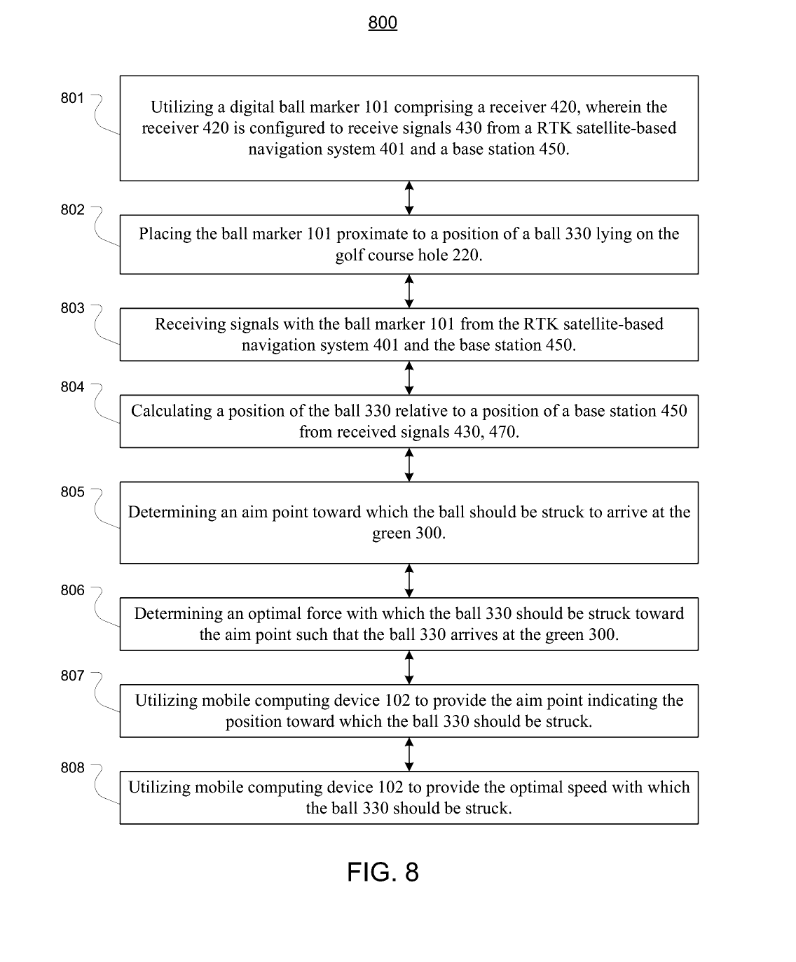

FIG. 8 illustrates a flowchart of an exemplary method 800 for generating recommended golf shot parameters for striking a golf ball 330 from a tee box 240 to a green 300 or desired position in a fairway 230. Method 800 can be implemented by a mobile computing device such as a golfer's smart phone or other device carried by the golfer. In some embodiments, method 800 can comprise a step 801 of utilizing a digital ball marker 101 comprising a receiver 420, wherein the receiver 420 is configured to receive signals 430 from a RTK satellite-based navigation system 401 and a base station 450. In other embodiments, method 800 can comprise a step 802 of placing the ball marker 101 proximate to a position of a ball 330 lying on the golf course hole 220. In yet other embodiments, the method 800 can comprise a step 803 of receiving signals with the ball marker 101 from the RTK satellite-based navigation system 401 and the base station 450. In some embodiments, the method 800 can comprise a step 804 of calculating a position of the ball 330 relative to a position of a base station 450 from received signals 430, 470. In other embodiments, the method 800 can comprise a step 805 of determining an aim point toward which the ball should be struck to arrive at the green 300. In yet other embodiments, the method 800 can comprise a step 806 of determining an optimal force with which the ball 330 should be struck toward the aim point such that the ball 330 arrives at the green 300. In some embodiments, the method 800 can comprise a step 807 of utilizing mobile computing device 102 to provide the aim point indicating the position toward which the ball 330 should be struck. In other embodiments, the method 800 can comprise a step 808 of utilizing mobile computing device 102 to provide the optimal speed with which the ball 330 should be struck.

Smartphone Application

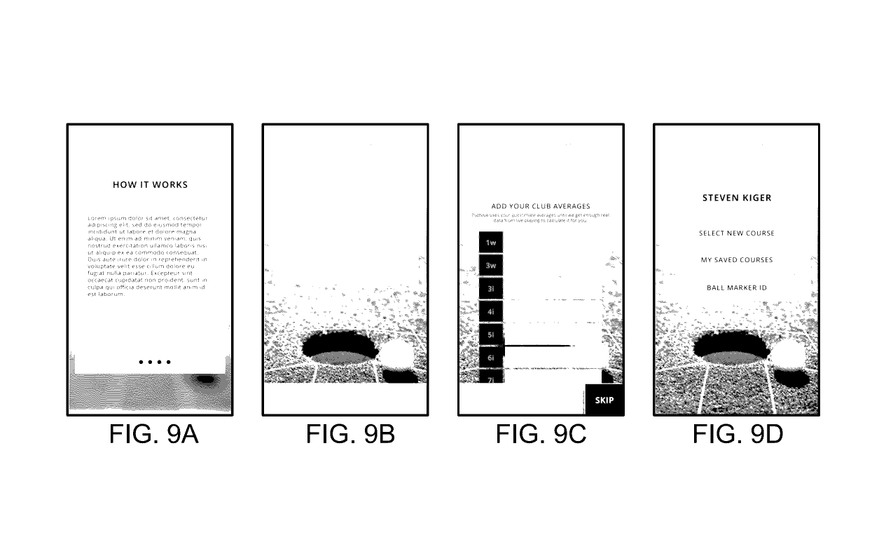

In some embodiments, the system for improving golf stroking can further comprise a software application configured to operate on mobile computing device 102. The software application can be configured to be compatible with smartphone operating systems including iOS, Windows Mobile, Windows Phone, Blackberry, Android, and any other suitable smartphone operating system. In other embodiments, the software application can be configured as a web-based interface and can be accessed from any Internet-enabled mobile device or computer. In yet other embodiments, the software application can be integrated into a social media platform. In some embodiments, the software application can act as a graphical user interface to allow a player to operate the ball marker 101 and/or the mobile computing device 102. FIGS. 9-12 illustrate representations of screen shots of some embodiments of the software application for the system for improving golf stroking.

FIGS. 9A-9D illustrate some embodiments of screen shots that can be displayed during the initial startup of the software application. FIG. 9A illustrates an embodiment of a screen shot that can be displayed as part of a tutorial to instruct the player in the use of the software application and the system for improving golf stroking. FIG. 9B illustrates an embodiment of a screen shot for a login screen that can be configured to allow a player to login to the software application. In some embodiments, a player can create a user profile as part of the login process. The user profile can comprise a player's golfing characteristics, including skill level, handicap, golfing style, clubs used by golfer, average distance achieved per club type, and any other relevant information. FIG. 9C illustrates an embodiment of a screen shot for an option that can allow a player to enter the average distance that the player achieves with each individual club. FIG. 9D illustrates an embodiment of a screen shot for a welcome screen that can allow a player to select a new course, review saved courses, and/or input the identification number of a rented or borrowed ball marker 101. In some embodiments, a player can rent or borrow a ball marker 101 for use on a golf course. In other embodiments, a ball marker can be shared by a group or team of golf players.

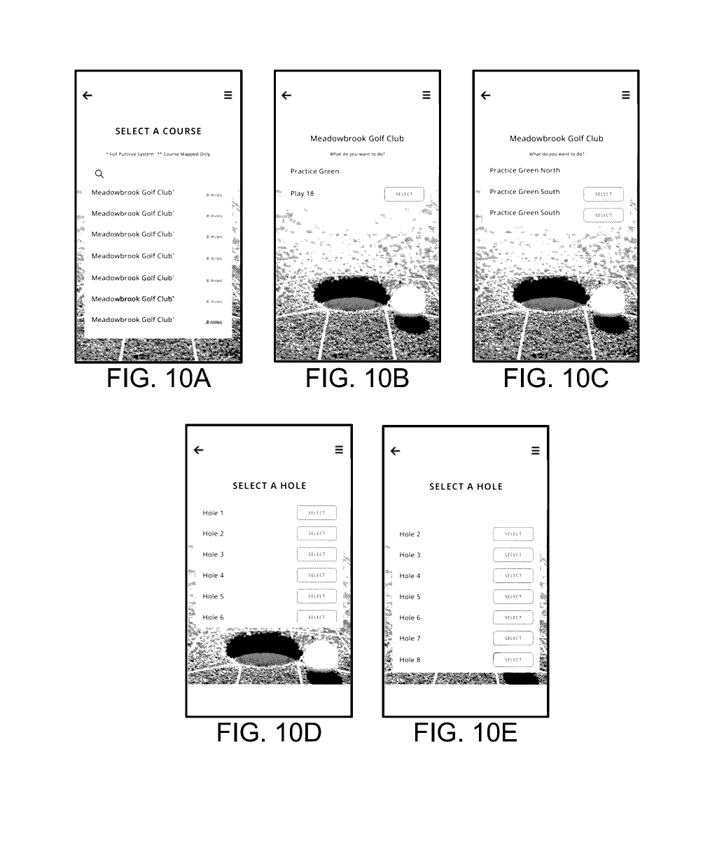

FIGS. 10A-10E illustrate some embodiments of screen shots that can be displayed as a player begins game play or practice play. FIG. 10A illustrates an embodiment of a screen shot that can be displayed to allow a player to select a golf course. In some embodiments, the software application can detect the player's location and can display any golf course that is nearby. In other embodiments, the software application can allow a player to enter a name of a golf course. In yet other embodiments, the software application can allow a player to recall a golf course previously played. FIG. 10B illustrates an embodiment of a screen shot that can be displayed to allow a player to select to practice or to play a round of golf. In some embodiments, practice can include practicing longer shots, for example, driving. In other embodiments, practice can include practicing putting shots including practicing on a practice green. In yet other embodiments, a player can elect to play a full eighteen holes of golf. In some embodiments, a player can elect to play less than eighteen holes of golf. FIG. 10C illustrates an embodiment of a screen shot that can be displayed to allow a player to select a particular practice green during a practice round. FIGS. 10D and 10E illustrate embodiments of screen shots that can be displayed to allow a player to select a particular hole for play during a round of golf.

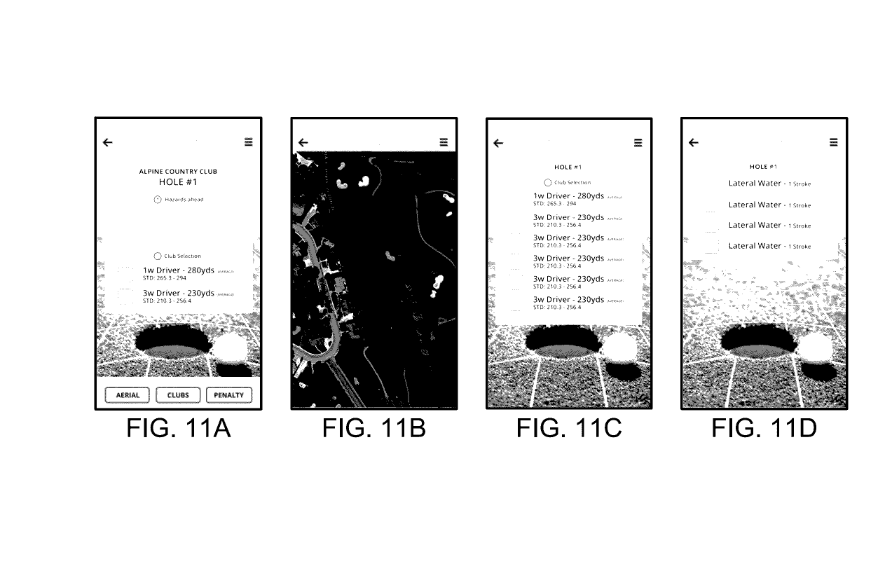

FIGS. 11A-11D illustrate some embodiments of screen shots that can be displayed as a player drives the ball 330 from the teeing ground 240 to the green 300. FIG. 11A illustrates an embodiment of a screen shot that can be used to display information from a particular hole to a player. In some embodiments, the software application can indicate to the player the nature and location of any relevant hazards for a particular golf course hole 220. In other embodiments, the software application can allow the player to indicate the club that will be used. In yet other embodiments, the software application can indicate to the player the player's average distances per club. In some embodiments, the software application can allow the player to select from other options including an aerial view of the golf course hole 220, a listing of clubs available for selection, and/or a listing of penalties corresponding to hazards on the golf course hole 220. FIG. 11B illustrates an embodiment of a screen shot that can be used to display an aerial view of the golf course hole 220. In some embodiments, the aerial view can be a satellite image of the golf course hole 220. In other embodiments, the aerial view can be a drawing or depiction of the golf course hole 220. In yet other embodiments, the aerial view can be a topographic map with contour lines of the golf course hole 220. In some embodiments, the aerial view can be an aerial photograph of the golf course hole 220.

FIG. 11C illustrates an embodiment of a screen shot that can be used to display a selection of clubs for a particular golf course hole 220. In some embodiments, the software application can list a player's available clubs. In other embodiments, the software application can list a player's available clubs along with the player's average distance with each club. In yet other embodiments, the software application can list a recommended club and/or multiple recommended clubs and/or shot types. In some embodiments, the software application can list the range of the player's distances for each club. FIG. 11D illustrates an embodiment of a screen shot that can be used to display a list of penalties corresponding to hazards on the golf course hole 220. In some embodiments, a player can indicate if the player's ball 330 landed in any of the listed hazards and the corresponding stroke penalty can be assessed against the player.

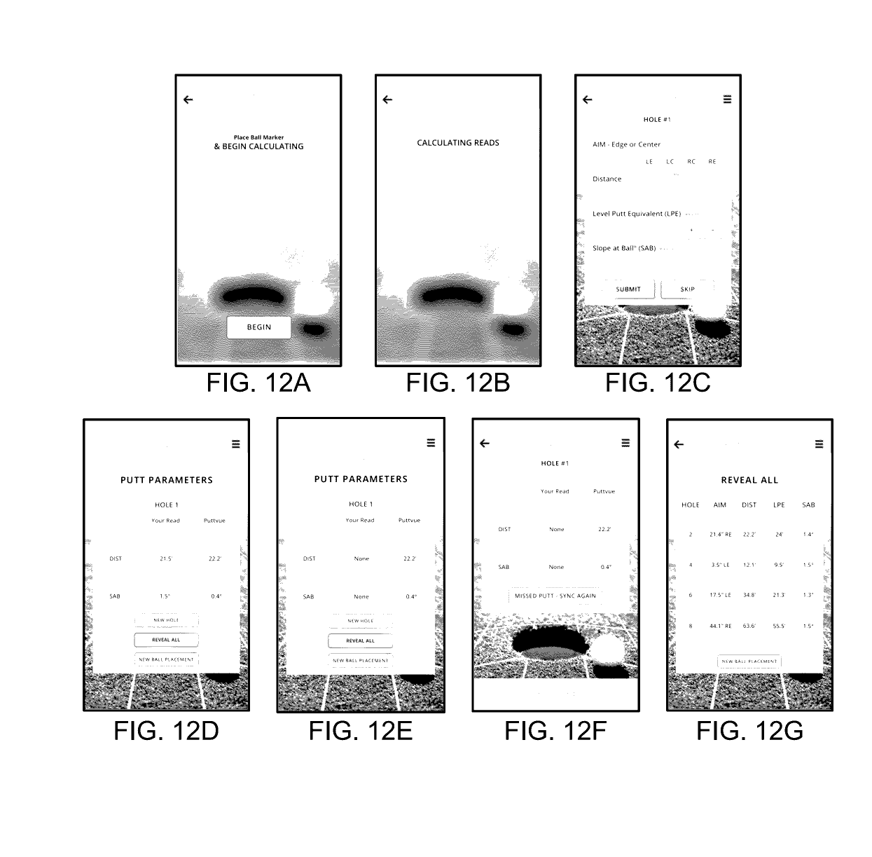

FIGS. 12A-12G illustrates embodiments of screen shots that can be displayed as a player putts the ball 330 on the green 300. In other embodiments, the embodiments of the screen shots can also be displayed if a player fails to reach the green 300 on the first stroke and must take subsequent stroke(s) to reach the green 300. FIG. 12A illustrates an embodiment of a screen shot that can be used to indicate to the player that the ball marker 101 can be placed proximate to the ball 300 and activated. In some embodiments, the ball marker 101 can be activated with the software application. In other embodiments, the ball marker 101 can be activated from the input module 202. FIG. 12B illustrates an embodiment of a screen shot that can be used to indicate to the player that the recommended golf shot parameters are being determined. FIG. 12C illustrates an embodiment of a screen shot that can be used by the player to input the player's estimates for the recommended golf shot parameters for the particular shot. In some embodiments, the player's estimates for the recommended golf shot parameters can include estimated direction of aim, estimated distance to cup 322, estimated level putt equivalent, and/or estimated slope at ball. In other embodiments, the estimated direction of aim can be input in terms of left edge (LE) of cup 322, left center (LC) of cup 322, right center (RC) of cup 322, and/or right edge (RE) of cup 322.

FIG. 12D illustrates an embodiment of a screen shot that can be used to indicate to the player the recommended putt parameters in comparison to the player's estimated putt parameters. In some embodiments, the player can review the comparison of recommended putt parameters to the player's estimated putt parameters for each hole individually. In other embodiments, the player can select a new hole. In yet other embodiments, the player can select a new ball placement. In some embodiments, the player can select to reveal the recommended and estimated parameters for all holes that have been played. FIG. 12E illustrates an embodiment of a screen shot that can be used to indicate to the player the recommended putt parameters in comparison to the player's estimated putt parameters if a player has not entered in any estimates. In some embodiments, if a player does not enter the player's estimated parameters, the software application will display the estimated parameters as “none” or “not entered.” FIG. 12F illustrates an embodiment of a screen shot that can be used to indicate to the player the recommended putt parameters in comparison to the player's estimated putt parameters and can allow the player to input that the player made the shot or that the player missed the shot. In some embodiments, the player indicates that the player made the shot and the software application advances to the next hole. In other embodiments, the player indicates that the player missed the shot and the software application can be used to indicate to the player that the ball marker 101 can be placed proximate to the ball 300 and activated. FIG. 12G illustrates an embodiment of a screen shot that can be used to indicate to the player the recommended putt parameters in comparison to the player's estimated putt parameters for each hole that has been played. In some embodiments, the software application can indicate to the player the recommended putt parameters in comparison to the player's estimated putt parameters for a current game in comparison to previously played games.

### APPENDIX 1

In some embodiments, the recommended putt and/or stroke parameters are determined by a path solver function. In some aspects, the path solver function can be configured to find the best path as a function of a starting angle. In other aspects, the path solver function can be configured to use a binary search algorithm to find an angle parameter of the recommended putt and/or stroke parameters. In yet other aspects, the path solver function can determine starting parameters by utilizing a physics engine and then adjust these starting parameters to find a best path. In other embodiments, the recommended putt and/or stroke parameters are determined by a path solver function configured to function as shown below in Table 1.

TABLE 1
Path Solver

```
%Path Solver Code%%%%%%%%%%%%%%%%%%%%%%%%%
int main(int argc, char **argv)
{
    int retval = 0;
    const int iterations = 12;
    if(argc == 1 | | argc == 2 && string(argv[1]) == ″--help″)
    {
        print_help(argv[0]);
        exit(0);
    }
    if(argc == 2 && string(argv[1]) == ″--version″)
    {
        print_version( );
        exit(0);
    }
    try
    {
        PathSolver solver(argc, argv);
        solver.CalculatePath( );
        precise_t startAngles[2];
        for(int i = 0; i < iterations; ++i)
        {
            solver.GetPlusMinusAngles(i, startAngles);
            solver.CalculatePath(startAngles[0]);
            solver.CalculatePath(startAngles[1]);
            if(solver.is_accurate( ))
                break;
        }
        cout << solver << endl;
    }
    catch(exception &e)
    {
        cerr << ″An exception occurred: ″ << e.what( ) << endl;
        retval = −1;
    }
    return retval;
}
%End Path Solver Code%%%%%%%%%%%%%%%%%%
%%%%%%%%%%%%%%
```

In some embodiments, the recommended putt and/or stroke parameters are determined by a path solver function using starting parameters. Starting parameters can comprise one or more of starting position, starting speed, and starting angle. In some embodiments, starting position comprises a hole (or cup) position). In some aspects, the starting position can comprise a hole (or cup) position because the path solver function solves the path from the position of the hole to the position of the ball.

In some embodiments, the starting speed is determined theoretically based on a “distance past the hole” parameter and the slope of the plane at the hole location. In some instances, an approximation can be made by assuming that the hole lays on a sloped planar surface. An acceleration of a sphere rolling on a sloped planar surface in the direction of the gradient when using a constant frictional acceleration can be used to determine a starting speed. In some aspects the acceleration of a sphere rolling on a sloped planar surface in the direction of the gradient when using a constant frictional acceleration can be calculated by:

$${a}_{plane} = \frac{5}{7} g ( {ρ}_{g} \pm \sqrt{{( \frac{d z}{d x} )}^{2} + {( \frac{d z}{d y} )}^{2}} )$$

In some aspects, g is the acceleration of gravity, ρg is the frictional constant, and the terms in the square root are derivatives of the plane in the x and y direction. The acceleration can be larger depending when the sphere is rolling up the gradient (+) or smaller when the sphere is rolling down the gradient (−).

In some embodiments, the approximate acceleration is used to find the speed necessary for the ball to travel the desired distance (the distance beyond the hole) in the up direction and the down directions by using:

V_{up\down}=(\sqrt{2daₚₗₐₙₑ})

Since the speed must be between these two speeds, the speed in any direction required to roll the desired distance past the hole can be approximated by:

$$Vstart = \frac{( {V}_{up} - {V}_{down} )}{2} ( 1 - cos ( φ - θ ) + {V}_{down}$$

Where Φ is the angle of the gradient and θ is the angle we wish to roll the sphere.

In some embodiments, the starting angle is the angle that intersects with a current ball position. The starting angle can be determined by a function as shown below in Table 2.

TABLE 2
Calculate Starting Speed and Velocity Vector

```
%%%Calculate Starting Speed and velocity vector code%%%
void FitData::CalculateVstart(precise_t dph, precise_t angle,
precise_t rhog)
{
    precise_t RadianAngle = angle*PI / 180;
    precise_t magicvalue = 0.714286;
    //----------CALCULATE LOCAL X,Y AND ABSOLUTE
    XYZ----------
    precise_t XL = r.x − dx*xindex;
    precise_t yL = r.y − dx*yindex;
    r.z = fit[0] + fit[1] * XL + fit[2] * yL + fit[3] * xL*yL + fit[4]
* xL*xL + fit[5] * yL*yL;
    //-------------------- DERIVATIVES--------------------
    precise_t mx = fit[1] + fit[3] * yL + 2 * fit[4] * XL;
    precise_t my = fit[2] + fit[3] * XL + 2 * fit[5] * yL;
    //-------------------- CALCULATE INITIAL VELOCITY ----------------
----
    precise_t phi = atan2(my, mx); //The angle of steepest ascent
from the hole location
    //------Calculate a up and and down steepest angle of ascent.
    // Becareful to cast 5 from an int to a precise_t, otherwise we
get integer division, not floating point
    precise_t ae1 = magicvalue * g*(rhog + sqrt(mx*mx + my*my)) /
sqrt(1 + mx*mx + my*my); // Should always be pos
    precise_t ae2 = magicvalue * g*(rhog − sqrt(mx*mx + my*my)) /
sqrt(1 + mx*mx + my*my); /* Can go negative
if hole is on a steep plane */
    if (ae2 <= 0)
        {ae2 = magicvalue * rhog*g*.25; //If slope acceleration is
greater than friction set it to 25% of5/7pg*g
    };
    precise_t vel = sqrt(2 * ae1*dph); //v up or down (not sure which)
along phi
    precise_t ve2 = sqrt(2 * ae2*dph);
    //v be enough to only roll (dph) inches up and down
    //--------------------Estimate the magnitude of velocity in the
direction of Theta
    // based on this function below:
    precise_t vMag = (ve1 − ve2) / 2 * (1 − cos(RadianAngle − phi)) +
ve2;
    precise_t vx = cos(RadianAngle);
    precise_t vy = sin(RadianAngle);
    precise_t vz = vx*mx + vy*my;
    //-------------------- UPDATE v --------------------
    v.x = vMag*vx / sqrt(vx*vx + vy*vy + vz*vz);
    v.y = vMag*vy / sqrt(vx*vx + vy*vy + vz*vz);
    v.z = vMag*vz / sqrt(vx*vx + vy*vy + vz*vz);
}
%%%%Start angle code%%%%%%
startAngle = atan2((ball.y − hole.y), (ball.x − hole.x)) * 180 / PI;
```

In some embodiments, output parameters comprise one or more of aim direction, aim magnitude, initial putt speed, and/or relative putt distance. The aim direction can comprise a distance relative to the hole position (e.g. a distance left or right relative to the hole position). The aim magnitude can comprise a magnitude relative to the hole position (e.g. a magnitude in meters). The initial putt speed can comprise an initial speed of the ball when hit (e.g. in meters per second). The relative putt distance can comprise a relative difference in putt length if the putt was attempted on a flat, horizontal surface. Uphill puts can be indicated with positive values and downhill puts can be indicated with negative values.

In some embodiments, a path comprises a series of positions determined by a physics engine. In other embodiments, a best path comprises a path that comes closest to the hole position and comprises a velocity that allows the ball to stop nearest to the hole. In some aspects the distance between the hole and the calculated stopping position of the ball can comprise a parameter utilized by the path solver function.

In some embodiments, friction can be treated as a constant that opposes the velocity (the direction of a moving golf ball). The frictional constant ρ_{g} is related to the green speed Δx as shown:

$${ρ}_{g} = \frac{7 {v}_{s}^{2}}{10 g Δ x}$$

In some aspects, g is the gravitational constant 9.8 m/ŝ2, Vs is the speed of the standard stimp meter speed (1.81 m/s), and Δx is the green speed reading in meters. In other aspects, the e frictional acceleration can be calculated by:

$${a}_{f} = \frac{{ρ}_{g} g}{1 + {I}_{b}}$$

with ρ_{g} representing the frictional constant and I_{b} representing the moment of inertia of a sphere.

In some embodiments, reverse friction is also considered. Rather than opposing the direction of the velocity, the reverse path can be calculated by accelerating in the direction of the velocity. Solving by taking into account reverse friction can be advantageous because solving the correct putt path is a function of initial speed and direction. By starting at the hole, the speed variable can be eliminated by setting it to a theoretical value thereby requiring that only the angle be solved to determine the path nearest the ball position. This in turn makes determining the path nearest the ball position more efficient and faster. In some cases, the path nearest the ball position can be calculated in about 0.01 seconds.

In some embodiments, the path solver function comprises a physics engine. The physics engine can comprise an Euler midpoint numerical method to calculate position one step at a time. The time at which the positions are calculated (tau) can be a parameter and can be in the range of about 0.1 seconds to 0.00001 seconds.

In some embodiments, the physics engine comprises a processor configured to carry out one or more of calculating local fit, determining fit derivatives, calculating acceleration, updating velocity, updating position, and/or any other suitable function.

Calculate local fit can include accurately calculating the acceleration of a sphere rolling on a curved surface by determining the spatial derivatives and second derivatives. Because taking direct derivatives of real world DTM typically yields jagged discontinuous derivatives and it is required that the sphere roll in a smooth and continuous fashion over the surface, the derivatives can be found from a surface fit. In some aspects, the surface fit can be found by finding about 25 neighboring rest points among the z-axis data points (e.g. along the height) from the DTM at the current ball position. Next, the spacing of these points is used in a least squares fitting technique to fit the z data points to a three dimensional parabola of form:

z=a+bx+cy+dxy+ex²+fy²

In other embodiments, calculating local fit may be accomplished as shown below in Table 1.

TABLE 3
Local Fit Code

```
void GreenData::CalculateFit(FitData &fit)
{
  //use x, location[0] and y, location[1] to get xindx and yindx
  size_t newx = round(fit.r.x / dx);
  size_t newy = round(fit.r.y / dx);
  if((fit.xindex != newx) || (fit.yindex != newy))
  {
    //If the indexes are different the local fit will be different
update: indexes, nearest points, fit array
    fit.xindex = newx;
    fit.yindex = newy;
    //use indx's to get 25 points (square matrix) and assign to id array
    for(int iy = −2; iy <= 2; ++iy)
      for(int ix = −2; ix <= 2; ++ix)
        fit.closestZPoints[5 * (iy + 2) + (ix + 2)] =
        get_item(fit.xindex + ix, fit.yindex + iy);
    //multiply Fitoperator*closestZPoints to get FitArray
    for(int i = 0; i < 6; ++i){
      fit.fit[i]=0; //Set to zero
      for(int j = 0; j < 25; ++j)
        fit.fit[i] += FitOperator[i][j] * fit.closestZPoints[j];
    }
  }
}
```

Determining fit derivatives can be carried out by determining the following derivatives to determine the acceleration:

$$\frac{{\partial }^{2} z}{\partial {x}^{2}} , \frac{\partial {z}^{2}}{\partial x \partial y} , \frac{{\partial }^{2} z}{\partial {y}^{2 }} , \frac{\partial z}{\partial x} , \frac{\partial z}{\partial y}$$

In some embodiments determining fit derivatives may be accomplished as outlined in Table 4 below.

TABLE 4
Code Derivatives

```
//----------CALCULATE LOCAL X,Y AND ABSOLUTE XYZ----------
  precise_t xL = r.x − dx*xindex;
  precise_t yL = r.y − dx*yindex;
  r.z = fit[0] + fit[1] * xL + fit[2] * yL + fit[3] * xL*yL +
  fit[4] * xL*xL + fit[5] * yL*yL;
  //-------------------- DERIVATIVES--------------------
  precise_t mx = fit[1] + fit[3] * yL + 2 * fit[4] * xL;
  precise_t my = fit[2] + fit[3] * xL + 2 * fit[5] * yL;
```

Calculating acceleration can be carried out by considering that the acceleration of a sphere rolling on a somewhat flat but curved surface is a function of velocities (time derivatives in x and y), first and second order spatial derivatives (above), g, the moment of inertia of a sphere I_{b}, and the acceleration due to friction (af). In some aspects, acceleration can be calculated by:

$${a}_{x} = \frac{- \frac{\partial z}{\partial x} ( \frac{{\partial }^{2} z}{\partial {x}^{2}} {( \frac{d x}{d t} )}^{2} + 2 ( \frac{\partial {z}^{2}}{\partial x \partial y} ) \frac{d y}{d t} ( \frac{d x}{d t} ) + \frac{{d}^{2} z}{d {y}^{2}} {( \frac{d y}{d t} )}^{2} + \frac{g}{1 + {I}_{b}} )}{{( \frac{d x}{d t} )}^{2} + {( \frac{d y}{d t} )}^{2} + 1} + {a}_{fx}$$

$${a}_{y} = \frac{- \frac{\partial z}{\partial y} ( \frac{{\partial }^{2} z}{\partial {x}^{2}} {( \frac{d x}{d t} )}^{2} + 2 ( \frac{\partial {z}^{2}}{\partial x \partial y} ) \frac{d y}{d t} ( \frac{d x}{d t} ) + \frac{{d}^{2} z}{d {y}^{2}} {( \frac{d y}{d t} )}^{2} + \frac{g}{1 + {I}_{b}} )}{{( \frac{d x}{d t} )}^{2} + {( \frac{d y}{d t} )}^{2} + 1} + {a}_{fy}$$

$${a}_{z} = \frac{\partial z}{\partial x} {( \frac{d x}{d t} )}^{2} + 2 ( \frac{\partial {z}^{2}}{\partial x \partial y} ) \frac{d y}{d t} ( \frac{d x}{d t} ) + \frac{{d}^{2} z}{d {y}^{2}} {( \frac{d y}{d t} )}^{2} + \frac{\partial z}{\partial x} ( {a}_{x} ) + \frac{\partial z}{\partial y} ( {a}_{y} ) + {a}_{fz}$$

In some embodiments, calculating acceleration may be accomplished as outlined in Table 5 below.

TABLE 5
Acceleration Code

```
//-------------------- CALCULATE ACCELERATION ----------
  c = mx*mx + my*my + 1;
  k = nx*v.x * v.x + 2 * fit[3] * v.x * v.y + ny*v.y * v.y;
  ax = −mx*(k + g / (1 + Ib)) / c;
  ay = −my*(k + g / (1 + Ib)) / c;
  az = k + mx*ax + my*ay;
  fv.x = 1 / (1 + Ib)*rhog*g*v.x / sqrt(v.x * v.x + v.y * v.y + v.z * v.z);
//-----FRICION FORCES X
  fv.y = 1 / (1 + Ib)*rhog*g*v.y / sqrt(v.x * v.x + v.y * v.y + v.z * v.z);
//-----FRICION FORCES Y
  fv.z = 1 / (1 + Ib)*rhog*g*v.z / sqrt(v.x * v.x + v.y * v.y + v.z * v.z);
//-----FRICION FORCES Z
  //add friction for reverse friction
  a.x = ax + fv.x;
  a.y = ay + fv.y;
  a.z = az + fv.z;
```

Updating velocity can be carried out by:

v=vₒ+at

where v is the updated velocity and vo is the previous velocity. In some embodiments updating velocity may be accomplished as outlined in Table 6 below.

TABLE 6
Updating Velocity Code

```
//-------------------- UPDATE v --------------------
  v.x = v.x + tau*a.x;
  v.y = v.y + tau*a.y;
  v.z = v.z + tau*a.z;
```

Updating position can be carried out by:

r=rₒ+vt+½at²

where r is the updated position, v is the updated velocity, and a is the net acceleration. In some embodiments, updating position may be accomplished as outlined below in Table 7.

TABLE 7
Updating Position Code

```
//-------------------- UPDATE r --------------------
  r.x = r.x + tau*(2 * v.x − tau*a.x) / 2;
  r.y = r.y + tau*(2 * v.y − tau*a.y) / 2;
  r.z = r.z + tau*(2 * v.z − tau*a.z) / 2;
```

The terms “a,” “an,” “the” and similar referents used in the context of describing the invention (especially in the context of the following claims) are to be construed to cover both the singular and the plural, unless otherwise indicated herein or clearly contradicted by context. Recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein is intended merely to better illuminate the invention and does not pose a limitation on the scope of the invention otherwise claimed. No language in the specification should be construed as indicating any non-claimed element essential to the practice of the invention.

It is contemplated that numerical values, as well as other values that are recited herein are modified by the term “about”, whether expressly stated or inherently derived by the discussion of the present disclosure. As used herein, the term “about” defines the numerical boundaries of the modified values so as to include, but not be limited to, tolerances and values up to, and including the numerical value so modified. That is, numerical values can include the actual value that is expressly stated, as well as other values that are, or can be, the decimal, fractional, or other multiple of the actual value indicated, and/or described in the disclosure.

Groupings of alternative elements or embodiments of the invention disclosed herein are not to be construed as limitations. Each group member may be referred to and claimed individually or in any combination with other members of the group or other elements found herein. It is anticipated that one or more members of a group may be included in, or deleted from, a group for reasons of convenience and/or patentability. When any such inclusion or deletion occurs, the specification is deemed to contain the group as modified thus fulfilling the written description of all Markush groups used in the appended claims.

Certain embodiments of this invention are described herein, including the best mode known to the inventors for carrying out the invention. Of course, variations on these described embodiments will become apparent to those of ordinary skill in the art upon reading the foregoing description. The inventor expects skilled artisans to employ such variations as appropriate, and the inventors intend for the invention to be practiced otherwise than specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

In closing, it is to be understood that the embodiments of the invention disclosed herein are illustrative of the principles of the present invention. Other modifications that may be employed are within the scope of the invention. Thus, by way of example, but not of limitation, alternative configurations of the present invention may be utilized in accordance with the teachings herein. Accordingly, the present invention is not limited to that precisely as shown and described.

I claim:

1. A system for generating data to provide an interactive user interface correlated with striking a golf ball, the system comprising:
a base station configured to receive carrier wave signals from a satellite-based navigation system and to transmit phase measurements of the carrier wave signals;
a server system comprising a topographical data set and configured to calculate recommended golf shot parameters using a position of a ball, a known position of a hole, and the topographical data set; and
a digital ball marker comprising:
a receiver configured to receive signals from the global navigation satellite system and to receive phase measurements of the carrier wave signals from the base station, wherein the ball marker calculates the position of the ball by using the received signals and the received phase measurements;
a communication module configured to transmit the position of the ball to the server system and to receive the recommended golf shot parameters for putting the ball into the hole; and
a display for displaying the recommended golf shot parameters;
wherein the digital ball marker is placed proximate to the position of the ball and activated to determine recommended golf shot parameters.

2. The system of claim 1, wherein the satellite-based navigation system comprises Global Positioning System, GLONASS, Galileo, COMPASS/Beidou2, Quasi-Zenith Satellite System (QZSS), or combinations thereof.

3. The system of claim 1, further comprising a Real Time Kinematic system, wherein the position of the base station is fixed and previously determined.

4. The system of claim 3, wherein the ball marker determines the position of the ball by:
calculating phase measurements from the signals received by the receiver;
comparing calculated phase measurements from the signals received by the receiver with the phase measurements received from the base station; and
using the fixed position of the base station.

5. The system of claim 1, wherein the base station transmits the phase measurements of the carrier wave signals to the receiver on a radio frequency.

6. The system of claim 1, wherein the receiver is configured to receive L1 signals, L2 signals, L2C signals, L5 signals, L5-like signals, E1 signals, E5 signals, L1C signals, radio frequency signals, cellular phone signals, Wi-Fi signals, Bluetooth signals, Near Field Communication signals, Internet communications, or combinations thereof.

7. The system of claim 1, wherein the base station is configured to receive L1 signals, L2 signals, L2C signals, L5 signals, L5-like signals, E1 signals, E5 signals, L1C signals, radio frequency signals, cellular phone signals, Wi-Fi signals, Bluetooth signals, Near Field Communication signals, Internet communications, or combinations thereof.

8. The system of claim 1, wherein the server system comprises a smartphone.

9. The system of claim 1, wherein the digital ball maker further comprises an accelerometer to determine slope.

10. The system of claim 1, wherein the topographical data set comprises satellite images of the golf course.

11. A digital ball marker for determining the location of a ball on a golf course, the ball marker comprising:
a receiver configured to receive signals from a global navigation satellite system and a base station, wherein the receiver calculates a position of the ball by using the received signals;
a communication module that transmits the position of a ball to a server system and receives recommended golf shot parameters for stroking the ball into the hole from the server system, the recommended golf shot parameters being calculated using the position of the ball, a known position of the hole, and a topographical data set of the golf course; and
a display for displaying the recommended golf shot parameters;
wherein the ball marker is placed on a surface of the golf course proximate to a position of the ball lying on the golf course and the ball marker is activated.

12. The ball marker of claim 11, further comprising a Real Time Kinematic system, wherein the position of the base station is fixed and previously determined.

13. The system of claim 12, wherein the ball marker determines the position of the ball by:
calculating phase measurements from the signals received by the receiver;
comparing calculated phase measurements from the signals received by the receiver with the phase measurements received from the base station; and
using the fixed position of the base station.

14. The system of claim 1, wherein the receiver is configured to receive L1 signals, L2 signals, L2C signals, L5 signals, L5-like signals, E1 signals, E5 signals, L1C signals, radio frequency signals, cellular phone signals, Wi-Fi signals, Bluetooth signals, Near Field Communication signals, Internet communications, or combinations thereof.

15. The system of claim 1, wherein the base station is configured to receive L1 signals, L2 signals, L2C signals, L5 signals, L5-like signals, E1 signals, E5 signals, L1C signals, radio frequency signals, cellular phone signals, Wi-Fi signals, Bluetooth signals, Near Field Communication signals, Internet communications, or combinations thereof.

16. The system of claim 1, wherein the digital ball maker further comprises an accelerometer to determine slope.

17. A system structured to generate data for display on an interactive user interface related to driving and putting a golf ball method comprising:
utilizing a digital ball marker comprising a receiver, wherein the receiver is configured to receive signals from a satellite-based navigation system and a base station;
placing the ball marker proximate to a position of a ball;
receiving signals with the ball marker from the global navigation satellite system and the base station;
calculating a position of the ball from the received signals;
determining an aim point toward which the ball should be struck from the position of the ball to arrive in a cup;
determining an optimal speed with which the ball should be struck toward the aim point such that the ball arrives in the cup;
utilizing the ball marker to provide the aim point indicating the position toward which the ball should be struck; and
utilizing the ball marker to provide the optimal speed with which the ball should be struck.

18. The system of claim 17, wherein the ball marker determines the position of the ball by:
calculating phase measurements from signals received by the receiver from the satellite-based navigation system;
comparing the calculated phase measurements from the signals received by the receiver with the phase measurements received from the base station; and
using the fixed position of the base station.

19. The system of claim 17, wherein the receiver is configured to receive L1 signals, L2 signals, L2C signals, L5 signals, L5-like signals, E1 signals, E5 signals, L1C signals, radio frequency signals, cellular phone signals, Wi-Fi signals, Bluetooth signals, Near Field Communication signals, Internet communications, or combinations thereof.

20. The system of claim 17, wherein the digital ball maker further comprises an accelerometer to determine slope.

21. A system for generating data utilized to populate an interactive user interface germane to striking a golf ball, the system comprising:
a base station configured to receive carrier wave signals from a satellite-based navigation system and to transmit phase measurements of the carrier wave signals;
a server system comprising a topographical data set and configured to calculate recommended golf shot parameters using a position of a ball, a known position of a hole, and the topographical data set;
a digital ball marker comprising a receiver configured to receive signals from the global navigation satellite system and to receive phase measurements of the carrier wave signals from the base station, wherein the ball marker calculates the position of the ball by using the received signals and the received phase measurements when the ball marker is placed proximate to the ball and activated;
a mobile computing device configured to relay the position of the ball from the ball marker to the server system, the mobile computing device configured to receive the recommended golf shot parameters and to display the recommended golf shot parameters.

22. The system of claim 21, wherein the ball marker determines the position of the ball by:
calculating phase measurements from the signals received by the receiver;
comparing calculated phase measurements from the signals received by the receiver with the phase measurements received from the base station; and
using the fixed position of the base station.

23. The system of claim 21, wherein the digital ball maker further comprises an accelerometer to determine slope.

24. The system of claim 21, wherein the server system calculates recommended golf shot parameters based at least in part on a player's previous performance at a particular hole.

25. The system of claim 21, wherein the server system calculates recommended golf shot parameters based at least in part on at least one other player's previous performance at a particular hole.
